(19) United States
(12) Patent Application Publication
(10) Pub. No.: US 2026/0291885 A1
(43) Pub. Date: Sep. 24, 2026

(54) SYSTEM

(71) Applicant: SoftBank Group Corp., Tokyo (JP)

(72) Inventor: Kazuhiro NINOMIYA, Tokyo (JP)

(73) Assignee: SoftBank Group Corp., Tokyo (JP)

(21) Appl. No.: 19/567,051

(22) Filed: Mar. 14, 2026

(30) Foreign Application Priority Data
Mar. 19, 2025 (JP) 2025-045134

(51) Int. Cl. H04L 51/02; G06F 40/289; G06F 40/30; G06N 3/0475; G10L 15/26

(52) U.S. Cl. CPC H04L 51/02; G06F 40/289; G06F 40/30; G06N 3/0475; G10L 15/26

(57) ABSTRACT

A system includes a processor that is configured to convert, in real time, utterances of participants from audio data into text data, input a prompt sentence into a generative artificial intelligence model to extract relevant keywords and generate new ideas, and present the generated ideas to the participants and collect feedback from the participants.

### CROSS-REFERENCE TO RELATED APPLICATION

This application is based on and claims priority under 35 USC 119 from Japanese Patent Application No. 2025-045134 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional brainstorming and early-stage product design processes rely heavily on manual facilitation, note-taking, and documentation. In such processes, participants' spoken utterances must be individually transcribed, analyzed, and organized by a human facilitator. Idea generation based on these utterances is typically performed manually, which can result in loss of information, bias, and inefficiency. Furthermore, transforming the collected ideas and feedback into formal artifacts such as requirements definition documents, concept sheets, and early design drawings or prototypes also requires substantial manual effort, specialized skills, and additional time. As a result, it is difficult to promptly and systematically convert real-time discussions into structured ideas, specifications, and visual designs, and this impedes rapid and iterative product development. The present invention has been made in view of these problems, and an object of the invention is to provide a system that automatically supports the entire flow from real-time capture of participants' utterances to idea generation, requirements and concept documentation, and prototype visualization by using generative artificial intelligence models and image generation techniques.

### SUMMARY

In order to solve the above-mentioned problems, a system according to one aspect of the present invention comprises a processor, wherein the processor is configured to convert, in real time, utterances of participants from audio data into text data, input a prompt sentence into a generative artificial intelligence model to extract relevant keywords and generate new ideas, and present the generated ideas to the participants and collect feedback from the participants. The processor is further configured to create a requirements definition document or a concept sheet based on the collected feedback. In addition, the processor is configured to generate, by using an image generation technique, a design drawing or a prototype based on the requirements definition document or the concept sheet. By integrating real-time speech-to-text conversion, automated idea generation using a generative artificial intelligence model, automatic creation of requirements and concept documentation from feedback, and automatic generation of design drawings or prototypes through an image generation technique, the system enables continuous and automated support from brainstorming to specification definition and visual prototyping, thereby efficiently solving the above-described problems.

The term “processor” refers to one or more hardware computing elements, such as a central processing unit, a graphics processing unit, a digital signal processor, or any combination thereof, capable of executing instructions to perform the functions described in the claims.

The term “utterances of participants” refers to spoken expressions, statements, comments, or questions made by human users during a session, which are captured as audio data and processed by the system.

The term “audio data” refers to digital data representing sound signals, including at least human speech, acquired via a microphone or other audio input device and suitable for processing by a speech recognition function.

The term “text data” refers to character-based digital data obtained by converting audio data into a textual representation of the spoken utterances, which can be further processed, analyzed, or stored by the system.

The term “prompt sentence” refers to one or more text strings that are input to a generative artificial intelligence model to specify instructions, context, constraints, or examples used by the model to generate output.

The term “generative artificial intelligence model” refers to a machine learning model, such as a large language model or another generative model, that is capable of producing new text or other content in response to input data including a prompt sentence.

The term “relevant keywords” refers to words or phrases extracted from the participants' utterances or from generated content that are determined, by the generative artificial intelligence model or by associated processing, to be significant for identifying or forming new ideas.

The term “new ideas” refers to concepts, proposals, or suggestions that are generated based on the participants' utterances and extracted relevant keywords, and that were not explicitly provided as such by the participants before generation.

The term “feedback” refers to responses, evaluations, comments, selections, corrections, or additional input provided by participants with respect to the generated ideas, which are collected and used by the system for further processing.

The term “requirements definition document” refers to a structured document describing functional and non-functional requirements, use cases, target users, and other specifications defining the behavior and constraints of a product or system.

The term “concept sheet” refers to a document summarizing an overall product or system concept, including at least an overview, value proposition, main features, and primary usage scenarios derived from the generated ideas and feedback.

The term “image generation technique” refers to a computational method that generates image data from input information, including but not limited to neural network based image generation models that produce visual content from textual or structured prompts.

The term “design drawing” refers to an image or set of images representing at least a structural, functional, or user interface design of a product or system, including wireframes, layout diagrams, or schematic representations generated by the image generation technique.

The term “prototype” refers to a preliminary visual or structural representation of a product or system, implemented as one or more images generated by the image generation technique, which illustrate appearance, layout, or interaction flow before final implementation.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

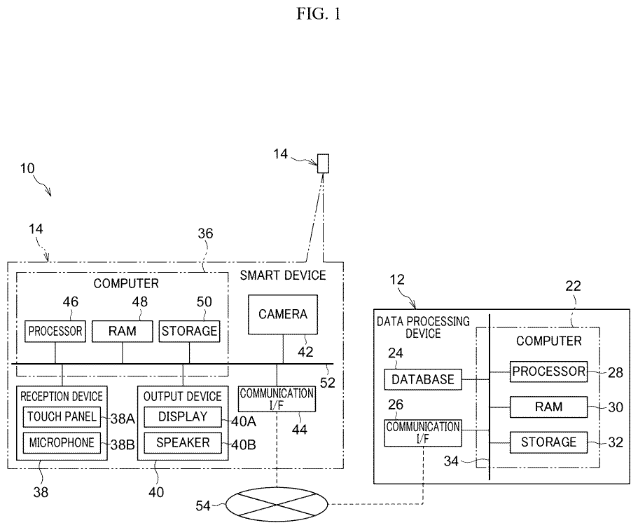

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

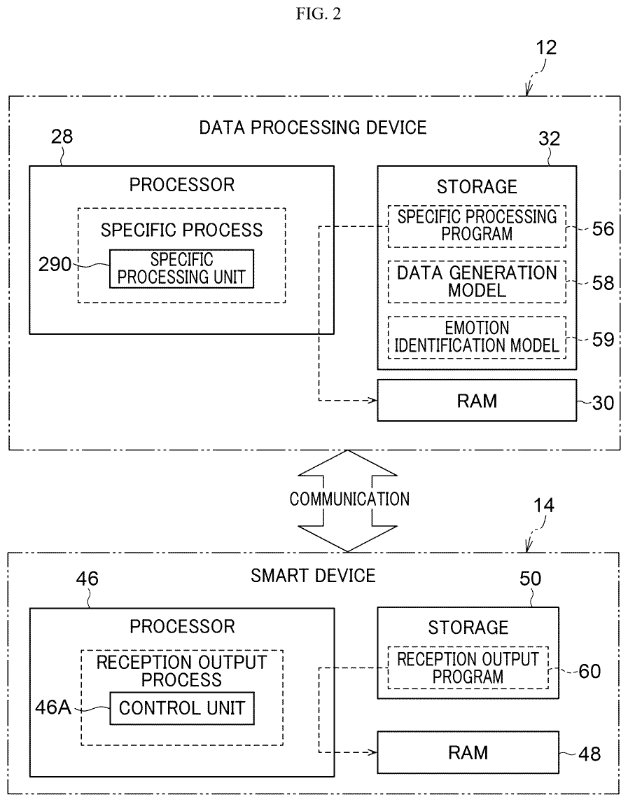

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60.

The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented brainstorming support techniques primarily treat speech recognition, keyword extraction, and idea generation as separate, loosely coupled components. In such techniques, audio capture at a terminal, speech-to-text conversion at a server, and idea generation by a machine learning model are typically orchestrated by static application logic that neither adapts to ongoing user interaction nor optimizes the end-to-end processing pipeline. As a result, the system often suffers from several technical shortcomings in terms of computer technology itself.

First, existing systems generally perform unstructured transcription and then apply fixed heuristic rules for keyword extraction and idea generation. Because the prompt sentences supplied to a generative artificial intelligence model are not dynamically formed from session-level storage information and feedback information, the model input frequently contains redundant or irrelevant content. This leads to inefficient use of computational resources, increased latency due to unnecessarily large model inputs, and degraded quality of generated output, thereby reducing the effectiveness of the system as an interactive computing tool.

Second, many known systems do not maintain explicit, session-based associations among audio information, character information, extracted related expressions, generated idea information, and feedback information within storage information. Without such structured associations, it is difficult for the processor to refine subsequent processing steps or to adjust model invocation conditions. This limitation manifests as rigid, non-adaptive workflows in which the same model configuration and prompt structure are used regardless of user behavior, resulting in suboptimal utilization of processor cycles, memory bandwidth, and network throughput.

Third, known brainstorming systems commonly lack an integrated mechanism by which feedback information is automatically fed back into the generative artificial intelligence model in a structured manner. Feedback is often stored as free-form text without being systematically used to regenerate or refine idea information. Consequently, idea refinement requires manual intervention by human operators, and the computing system fails to realize a self-optimizing loop that improves both the internal representations maintained in the storage information and the prompt sentences used for subsequent model invocations.

Fourth, conventional systems do not consistently transform the outputs of speech recognition and generative models into normalized structured information that can be directly consumed by downstream automated processes, such as automatic generation of specification documents or input to image generation processing models. The absence of such structured idea information forces later processes to rely on ad-hoc parsing or manual editing, which increases processing overhead and introduces latency and errors into the overall computer system.

Accordingly, there is a need for an improved computer-implemented system that (i) tightly integrates real-time audio processing, text preprocessing, and generative model invocation, (ii) maintains explicit, session-based associations among multiple kinds of information in storage, and (iii) dynamically generates and adjusts prompt sentences to a generative artificial intelligence model based on these associations and on feedback information. Such a system should improve the efficiency, responsiveness, and quality of idea generation and refinement, thereby improving the operation of the computer itself as a platform for interactive, model-driven brainstorming and design support.

The specific processing by the specific processing unit 290 of the data processing device 12 in Example 1 is realized by the following means.

The present invention provides a server comprising a processor configured to receive audio information transmitted from a terminal that acquires utterances of a participant, analyze the audio information, convert the audio information into character information in real time, and store the character information as storage information; preprocess the stored character information, generate a prompt sentence including the preprocessed character information, input the prompt sentence into a generative artificial intelligence model, and extract related expressions from an output of the generative artificial intelligence model; generate a prompt sentence including the extracted related expressions, input the prompt sentence into the generative artificial intelligence model, generate a plurality of idea information items based on an output of the generative artificial intelligence model, and store the idea information items as structured information in the storage information; convert the structured idea information into display data for the terminal and into audio output data, and transmit the display data and the audio output data to the terminal so as to present the structured idea information to the participant; collect evaluation information or comment information transmitted from the terminal as feedback information, store the feedback information as part of the storage information, generate a prompt sentence including the feedback information, input the prompt sentence into the generative artificial intelligence model, and update or additionally generate the idea information based on an output of the generative artificial intelligence model; and associate, on a session basis, the audio information, the character information, the related expressions, the idea information, and the feedback information, record the associated information in the storage information, and dynamically change generation conditions of the prompt sentence to be input into the generative artificial intelligence model based on the recorded association. This enables the computer system to form adaptive, context-aware prompt sentences and to iteratively refine generated idea information in response to user interaction, thereby improving computational efficiency, reducing processing latency, and enhancing the technical performance of the overall audio-to-idea processing pipeline.

The term “audio information” refers to digital data representing sound captured from a participant's utterances, including sampled waveform data or encoded audio frames that are transmitted from a terminal to the server for analysis.

The term “terminal” refers to an information processing apparatus operated by a participant, such as a computing device configured to capture audio, display information, and transmit and receive data via a communication network.

The term “participant” refers to a human user who provides utterances, evaluations, or comments to the system during a brainstorming or idea generation session.

The term “utterance” refers to a segment of spoken language produced by a participant and captured as audio information by the terminal.

The term “analyze the audio information” refers to performing signal processing and recognition operations on audio information, including at least decoding, feature extraction, and pattern matching, in order to derive character information corresponding to spoken content.

The term “character information” refers to text data representing linguistic content obtained by converting audio information into a sequence of characters or symbols in a natural language.

The term “real time” refers to processing that is performed with a latency sufficiently low that a participant perceives the system response as substantially contemporaneous with the participant's utterances.

The term “storage information” refers to data stored in a memory or storage medium of the server, including at least character information, related expressions, idea information, feedback information, and association information among these data.

The term “preprocess the stored character information” refers to applying text processing operations to character information, including at least segmentation, normalization, and removal of noise or filler content, in preparation for input to a generative artificial intelligence model.

The term “prompt sentence” refers to a structured input text, including instructions, context, and one or more data elements derived from storage information, that is supplied to a generative artificial intelligence model to control or guide its output.

The term “generative artificial intelligence model” refers to a machine-learned model configured to generate text or other content in response to an input prompt sentence, based on parameters obtained through training on example data.

The term “extract related expressions” refers to identifying, from an output of a generative artificial intelligence model or from character information, words or phrases that are determined to be relevant to a topic, theme, or context of a session.

The term “related expressions” refers to words or phrases that have been determined to have semantic relevance to one or more utterances, ideas, or tasks within a session, and that are used as elements for further idea generation.

The term “idea information” refers to data representing one or more proposed concepts, solutions, or suggestions generated at least in part by a generative artificial intelligence model based on prompt sentences including character information, related expressions, or feedback information.

The term “structured information” refers to idea information or other data that is organized according to a predefined data structure, such as records having fields including at least identifiers, titles, descriptions, and associated expressions, such that the data can be processed by subsequent automated procedures.

The term “display data” refers to data formatted for visual presentation on a terminal, including at least layout information, text content, and identifiers required for rendering idea information on a display device.

The term “audio output data” refers to data formatted for acoustic presentation on a terminal, including at least text to be converted to synthesized speech or encoded audio corresponding to such speech.

The term “present the structured idea information” refers to causing display data and/or audio output data to be output by the terminal so that a participant can perceive the generated ideas visually and/or aurally.

The term “evaluation information” refers to data representing a participant's assessment of idea information, including at least selections, ratings, or categorical judgments indicating a degree of preference or relevance.

The term “comment information” refers to text or transcribed speech provided by a participant, expressing opinions, suggestions, or modification requests regarding idea information.

The term “feedback information” refers to information collected from a participant that reflects reactions to or evaluations of idea information, including at least evaluation information and comment information.

The term “update or additionally generate the idea information” refers to revising existing idea information or creating new idea information by invoking a generative artificial intelligence model using prompt sentences that incorporate prior ideas and feedback information.

The term “associate, on a session basis” refers to linking multiple types of information, including at least audio information, character information, related expressions, idea information, and feedback information, with a common session identifier so that the information is treated as belonging to a single interactive session.

The term “session” refers to a logically grouped period of interaction between a participant and the system, during which utterances, generated ideas, and feedback are processed and stored with a common identifier.

The term “record the associated information” refers to storing in storage information data that explicitly represents the relationships among audio information, character information, related expressions, idea information, and feedback information within a session.

The term “dynamically change generation conditions” refers to modifying, during operation of the system and based on recorded association information, one or more parameters that control how prompt sentences are formed or how a generative artificial intelligence model is invoked, such as context selection, keyword emphasis, or model configuration.

The term “generation conditions of the prompt sentence” refers to rules, parameters, or criteria that determine the content, structure, or length of prompt sentences supplied to a generative artificial intelligence model, including at least which storage information elements are included and how they are combined.

In one embodiment, a server, a terminal, and a user cooperate to implement the invention as a computer-implemented brainstorming support system. The server includes at least one processor, a memory, a non-volatile storage device, and a network interface. The terminal includes at least a processor, a memory, a microphone, a display device, a speaker, and a communication interface. The user operates the terminal to provide utterances, view generated ideas, and submit feedback.

The server executes an operating system such as a general-purpose server operating system and runs application software that implements audio processing, text processing, interaction with a generative AI model, storage management, and user-session control. The terminal executes a client application, for example a native mobile application or a web application in a browser, that provides a user interface, captures audio via the microphone, and displays or plays back generated idea information.

The terminal uses an audio capture module to sample audio signals from the microphone at a predetermined sampling rate, for example 16 kHz, 16-bit linear PCM. The terminal converts the analog audio signal into digital audio frames using an analog-to-digital converter and stores the frames in a circular buffer in the terminal memory. The terminal encodes the buffered audio frames into an audio data format such as uncompressed PCM in a container or a compressed format such as a low-latency codec, and the terminal attaches metadata including a session identifier, a user identifier, a timestamp, and a language code. The terminal transmits the audio information as a data stream to the server through the communication interface using a communication protocol such as HTTPS or a bidirectional protocol such as WebSocket.

The server receives the audio information through the network interface and stores incoming packets in a reception buffer in the memory. The server executes a speech recognition module that can be implemented by a speech-to-text engine such as a cloud speech recognition service or an on-premise engine. The speech recognition module performs decoding of the audio stream, including framing, windowing, feature extraction (for example, computation of Mel-frequency cepstral coefficients), and acoustic model inference using a trained deep neural network. The acoustic model can be a neural network structure such as a recurrent neural network, a convolutional neural network, or a transformer-based encoder.

The server combines outputs of the acoustic model with a language model, such as an n-gram model or a neural language model, to decode the most likely sequence of tokens. The server converts this token sequence into character information representing textual transcription of the utterances.

The server stores the character information in storage information maintained in the non-volatile storage device. The storage information can be managed by a database management system, such as a relational database, and can be organized in tables including, for example, a table of utterances, a table of keywords, a table of ideas, and a table of feedback. Each record in the utterance table includes at least: a session identifier, a speaker identifier, a timestamp, and a text field containing the character information.

The server performs preprocessing of the character information using a text processing module implemented by a natural language processing library. The server segments the text into sentences, removes filler expressions and disfluencies, normalizes whitespace, converts characters to a normalized encoding, and optionally performs tokenization using a tokenizer compatible with a large-scale generative AI model. The server may also perform lemmatization and part-of-speech tagging. The preprocessed character information is stored back into the storage information and is associated with the original character information.

The server uses the preprocessed character information to generate a prompt sentence for a generative AI model. In one embodiment, the generative AI model is implemented by a transformer-based neural network trained on large-scale text data. The model architecture can include multiple layers of self-attention, multi-head attention, feed-forward networks, layer normalization, and positional encoding. The model receives tokenized text sequences and outputs probability distributions over a vocabulary for each position.

The server constructs the prompt sentence as a text string that includes an instruction portion and a context portion. The instruction portion may specify an operation such as keyword extraction, and the context portion may include concatenated preprocessed character information from the current session. For example, the server generates a prompt sentence such as:

“You are assisting a brainstorming session. From the text below, extract 10 relevant keywords (single words or short phrases) that are important for generating new service ideas. Return only a comma-separated list.

Text: ‘We want to use speech recognition and automatic translation to support multilingual online meetings and global customer service.”’

The server tokenizes this prompt sentence according to the vocabulary of the generative AI model, creates an input tensor, and transmits the tensor to the model execution environment.

The model execution environment may run on a specialized hardware accelerator such as a graphics processing unit or a tensor processing unit. The server receives the output token sequence from the model, decodes the tokens into text, and parses the output to extract the related expressions (keywords). The server normalizes the extracted expressions by trimming spaces, converting to a uniform case, and removing duplicates. The server stores the related expressions in the keywords table with links to the corresponding session identifier and utterance identifiers.

The server then generates another prompt sentence that includes the related expressions as input for idea generation. The instruction portion of this prompt sentence specifies generation of multiple ideas, and the context portion lists the extracted keywords. For example, the server generates a prompt sentence such as:

“You are a creative product designer. Using the following keywords, generate five innovative service ideas.

Keywords: speech recognition, automatic translation, multilingual, online meetings, global customer service.

For each idea, output a short title and a 3-sentence description.”

The server inputs this prompt sentence into the generative AI model in the same manner, receives the output text, and parses the text into items of idea information, such as title and description for each idea. The server structures the idea information in a predefined data schema, for example fields for an idea identifier, a title, a description, and associated keywords. The server stores the structured idea information in the ideas table within the storage information.

The server formats the structured idea information into display data for the terminal. The display data may be encoded in a document format such as HTML or a structured data format such as a hierarchical representation for the client application. The server also generates audio output data by either converting the idea text into a format suitable for text-to-speech synthesis at the terminal, or by invoking a server-side text-to-speech system and sending encoded audio. The server transmits the display data and the audio output data to the terminal over the communication network.

The terminal receives the display data and renders a user interface on the display device. The terminal creates visual components such as cards or list items for each idea, showing the title and the description. The terminal also receives the audio output data and drives the speaker to output synthesized speech corresponding to the idea descriptions, if the user enables audio playback. The user views and listens to the idea information, and the user operates interface controls on the terminal to provide evaluation information and comment information.

The user can, for example, select a “like” indicator for a certain idea, select a “refine” indicator, or input text describing desired modifications. The user can also provide spoken feedback using the microphone, such as “Focus more on remote teams and time zone differences, and add automatic meeting summaries.” The terminal captures this feedback as audio information and transmits it to the server in the same manner as the initial utterances.

The terminal also transmits structured feedback data such as an idea identifier and a selected rating.

The server stores the feedback information in the feedback table within the storage information. When audio feedback is provided, the server applies the speech recognition module to convert the feedback audio information into character information and associates the transcribed feedback text with the corresponding idea identifier and session identifier.

The server aggregates feedback information over time, computing metrics such as average ratings, counts of refinement requests, and frequency of certain terms in feedback text.

The server uses the feedback information together with the structured idea information to generate further prompt sentences for refinement of ideas. For example, the server may generate a prompt sentence such as:

“You are refining product ideas based on user feedback.

Original idea: ‘Multilingual Meeting Assistant-A cloud-based assistant joins online meetings, listens to all speakers using speech recognition, and provides real-time automatic translation into each participant's preferred language.’

User feedback: ‘Focus more on remote teams in different time zones, and add automatic meeting summaries.’

Task: Rewrite and extend the original idea to better serve remote teams in different time zones and to include automatic meeting summaries. Provide a new title and a 3-4 sentence description.”

The server inputs this prompt sentence into the generative AI model and obtains refined idea information. The server stores the refined idea information as new records in the ideas table and maintains a parent-child relationship between original ideas and refined ideas. The server then transmits the refined ideas to the terminal as updated display data, thereby enabling the user to iteratively refine concepts.

The server maintains, in the storage information, explicit associations on a session basis among audio information, character information, related expressions, idea information, and feedback information. To support this, the server uses session identifiers and foreign keys in the database schema so that each record in the utterances, keywords, ideas, and feedback tables references a common session record. The server also stores association records that indicate which related expressions contributed to the generation of which ideas, and which feedback entries resulted in refinement of which ideas.

The server uses these associations to dynamically change generation conditions of subsequent prompt sentences. For example, the server may adjust the selection of context text included in a prompt sentence based on which previous utterances led to highly rated ideas. The server may also adjust weighting of related expressions by increasing the emphasis of keywords that are frequently associated with positively rated ideas, and decreasing emphasis on keywords correlated with low-rated ideas. This can be implemented by a rule-based system or by a learned ranking model that selects and orders tokens to include in prompt sentences.

In one embodiment, the server implements an internal scoring mechanism that assigns scores to related expressions and ideas based on feedback information. The server modifies the prompt sentence by including high-scoring related expressions earlier in the prompt or by explicitly instructing the generative AI model to prioritize them. This non-conventional prompt construction pipeline results in more focused model outputs, reducing the amount of irrelevant generated text and thereby improving computational efficiency and reducing processing latency, since shorter and more relevant prompts require fewer computational operations in the generative AI model.

The generative AI model itself can be trained in advance using a supervised learning procedure. The training data can consist of pairs of input prompt sentences and desired output text, for tasks such as keyword extraction and idea generation. The server or an offline training system may use an error function such as cross-entropy loss between the predicted token distributions and the ground-truth token sequences. The model parameters, including weights in the attention layers and feed-forward layers, are updated using a gradient-based optimization algorithm such as stochastic gradient descent or Adam. During training, the system may perform data augmentation by rephrasing instructions or adding synthetic variations of brainstorming text, improving robustness of the model to diverse input styles.

The server may also implement additional algorithms to further improve computational efficiency and precision. For example, the server can perform token pruning by discarding low-importance segments of character information before constructing the prompt sentence, based on heuristics such as term frequency or on attention scores computed by a smaller auxiliary model. The server can also cache intermediate outputs of the generative AI model for repeated or similar prompt sentences, reducing redundant computations for similar brainstorming patterns across sessions.

The terminal may be implemented as a smartphone, a tablet, a laptop computer, or a desktop computer. In another embodiment, the terminal may be a specialized device, such as a dedicated meeting room terminal with an array microphone and a large display. The server may be implemented as a single physical machine or as a cluster of machines in a data center, and the generative AI model may be deployed on specialized hardware accelerators in the same data center or provided as an external service.

In another embodiment, the server uses the structured idea information and feedback information to automatically generate specification documents that include functional requirements, non-functional requirements, and usage scenarios. The server collects selected ideas and feedback from a session, constructs a document outline, and generates text for each section by using a generative AI model with prompt sentences tailored to specification writing. For example, the server may use a prompt sentence such as:

“Based on the following set of ideas and user feedback, generate a specification document including functional requirements, non-functional requirements, and usage scenarios for a new service. Write the document in structured sections.”

The server stores the generated specification document as part of the storage information and outputs it to the terminal as a file that can be downloaded or displayed. In yet another embodiment, the server uses the specification document and the structured idea information to produce prompt sentences for an image generation processing model, such as a generative model capable of synthesizing images or diagrams. The server inputs a prompt sentence describing desired configuration and appearance into the image generation model and receives image data that represents design drawings or prototypes. The server stores and outputs these image data as design or prototyping materials.

The described system improves computer technology itself by altering how the computer processes and manages data across the entire audio-to-idea pipeline. The server does not merely automate human brainstorming; instead, the server implements specialized data structures and dynamic prompt-generation algorithms that adapt the behavior of complex neural network models based on structured, session-level associations and feedback. This results in reduced processing latency because prompt sentences are constructed to be concise and relevant rather than including entire unfiltered transcripts. The structured storage of idea information and feedback information enables more accurate and efficient retrieval and reuse of context, which reduces memory access overhead and improves cache locality. The dynamic adjustment of prompt content and conditions based on session associations improves the precision of generated ideas, reducing the occurrence of irrelevant or low-quality outputs and thereby reducing the need for repeated model calls.

The server executes non-conventional processing steps that differ from simple human-style brainstorming or straightforward transcription workflows. For example, the server performs ranking and selection of related expressions, structured mapping of relationships between utterances and ideas, and iterative refinement loops that rely on quantitative feedback metrics. These steps use algorithmic rules and learned parameters that are not inherent in human mental processes, and the server applies these rules to control the flow of data to and from the generative AI model in a manner that optimizes hardware utilization and communication bandwidth.

Multiple variations of the embodiment are possible. The server may use different model architectures for the generative AI model, such as encoder-decoder transformers, and may allocate different models for keyword extraction and idea generation. The server may also use different database structures, such as document-oriented stores, for the storage information.

The terminal may provide different user interface layouts, such as timeline views or clustering of ideas by related expressions. The functions described in association with the server may be distributed across multiple servers, or some preprocessing may be offloaded to the terminal when local computing resources are sufficient.

In all of these embodiments, the server, the terminal, and the user cooperate so that audio information from the user is transformed into structured idea information using a generative AI model controlled by dynamically generated prompt sentences, and so that feedback information is systematically reintegrated into the data structures and processing logic of the system. Through this configuration, the invention provides a concrete improvement in the functioning of a computer system used for interactive brainstorming and design support.

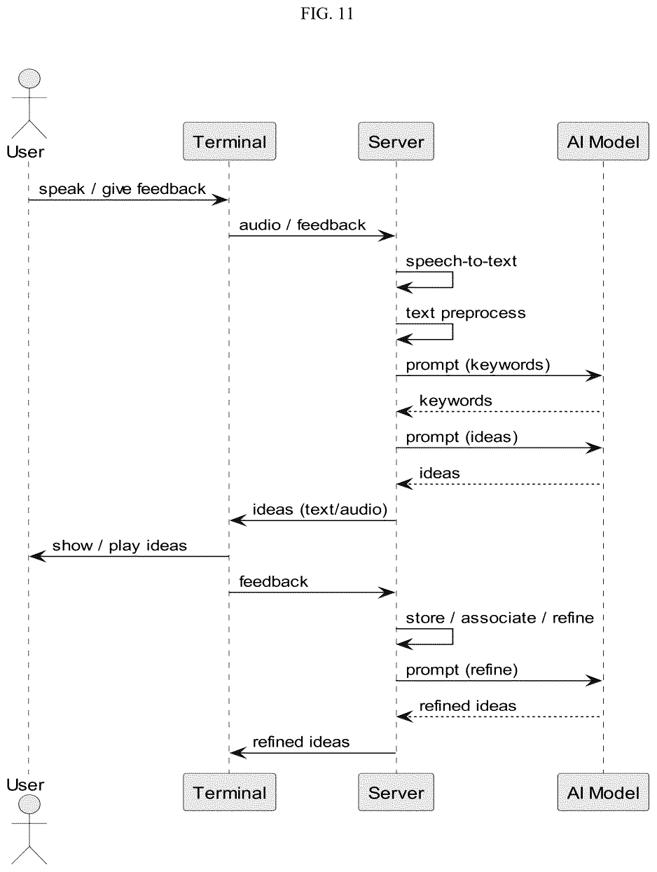

The following describes the processing flow using FIG. 11.

### Step 1:

The terminal captures utterances of the user as audio information. The terminal activates the microphone when the user starts a brainstorming session, samples the analog audio signal at a fixed sampling rate (for example, 16 kHz, 16-bit), and converts the samples into digital audio frames. The terminal groups the frames into chunks, attaches metadata such as a session identifier, a user identifier, a timestamp, and a language code, and encodes the data in a selected audio format. The terminal then transmits the audio chunks to the server via a network protocol. The input of Step 1 is an analog voice signal from the user, and the output of Step 1 is packetized digital audio information transmitted from the terminal to the server.

### Step 2:

The server receives the audio information and converts it into character information using a speech recognition process. The server stores incoming audio packets in a reception buffer and reconstructs the audio stream. The server applies signal processing operations such as framing, windowing, and feature extraction (for example, computing Mel-frequency cepstral coefficients) to the audio stream and feeds the resulting feature vectors into an acoustic model implemented by a neural network. The server combines outputs of the acoustic model with a language model to perform decoding and derive the most probable token sequence. The server maps the tokens to characters or words and generates text representing the user's utterances. The input of Step 2 is the digital audio information from the terminal, and the output of Step 2 is character information representing a textual transcription of the utterances.

### Step 3:

The server preprocesses the character information and stores it in storage information. The server performs operations such as sentence segmentation, removal of filler words, normalization of casing and punctuation, and tokenization using a natural language processing library. The server may also perform lemmatization and part-of-speech tagging to enrich the character information. The server writes the preprocessed character information into a database record associated with the current session and user, and links it to the original unprocessed transcription. The input of Step 3 is the raw character information produced in Step 2, and the output of Step 3 is normalized and tokenized character information stored as part of the storage information.

### Step 4:

The server generates a first prompt sentence for a generative AI model using the preprocessed character information as context. The server retrieves relevant text segments from the storage information for the current session, concatenates them into a context block, and constructs an instruction that specifies a keyword extraction task. The server combines the instruction and the context to form a prompt sentence such as: “You are assisting a brainstorming session.

From the text below, extract 10 relevant keywords (single words or short phrases) that are important for generating new service ideas. Return only a comma-separated list. Text:” . . . .

The server tokenizes this prompt sentence according to the vocabulary of the generative AI model and prepares an input tensor. The input of Step 4 is the normalized character information from Step 3, and the output of Step 4 is a tokenized prompt sentence ready for input to the generative AI model.

### Step 5:

The server executes the generative AI model to extract related expressions based on the first prompt sentence. The server supplies the tokenized prompt to a transformer-based generative AI model that includes self-attention layers and feed-forward networks. The model processes the tokens, computes attention weights to focus on semantically important parts of the context, and outputs a sequence of tokens representing a list of keywords. The server decodes the output tokens into text, splits the text into individual expressions, and normalizes each expression by trimming spaces and unifying case. The server stores the extracted related expressions as keyword records in the storage information, each linked to the corresponding session and utterances. The input of Step 5 is the tokenized prompt sentence from Step 4, and the output of Step 5 is a set of normalized related expressions stored in the storage information.

### Step 6:

The server generates a second prompt sentence for the generative AI model using the related expressions to request idea generation. The server selects a subset of related expressions based on criteria such as frequency or user emphasis and formats them as a keyword list in the prompt. The server composes an instruction such as: “You are a creative product designer. Using the following keywords, generate five innovative service ideas. Keywords: . . . . For each idea, output a short title and a 3-sentence description.” The server concatenates the instruction and the keyword list into a single prompt sentence, tokenizes it with the model's tokenizer, and constructs the corresponding input tensor. The input of Step 6 is the set of related expressions stored in Step 5, and the output of Step 6 is a tokenized idea-generation prompt sentence for the generative AI model.

### Step 7:

The server executes the generative AI model to generate idea information based on the second prompt sentence. The server applies the model in text generation mode, allowing it to sequentially output tokens that form titles and descriptions for multiple ideas. The server decodes the token sequence into text, detects boundaries between ideas (for example, using line breaks or numbered lists), and parses each idea into components such as title and description. The server populates a structured data schema with fields for idea identifier, title, description, and associated related expressions. The server writes these records into the ideas table in the storage information. The input of Step 7 is the tokenized idea-generation prompt from Step 6, and the output of Step 7 is structured idea information stored in the storage information.

### Step 8:

The server prepares presentation data from the structured idea information and transmits it to the terminal. The server retrieves the structured idea records for the current session, arranges them in a list or grouped format, and converts them into display data suitable for the user interface, including layout metadata and text strings. The server also prepares audio output data by packaging the idea text for text-to-speech synthesis or by generating synthesized speech and encoding it as audio. The server sends the display data and the audio output data to the terminal using a communication protocol. The input of Step 8 is the structured idea information from Step 7, and the output of Step 8 is display data and audio output data transmitted to the terminal.

### Step 9:

The terminal presents the idea information to the user and collects feedback information. The terminal parses the received display data and renders visual components on the display, such as cards that show titles and descriptions of ideas. The terminal optionally uses a text-to-speech engine to convert the idea text into spoken audio and plays it through the speaker. The user reads or listens to the ideas and interacts with the interface by selecting rating options, pressing refinement buttons, or entering text comments. If the user provides spoken feedback, the terminal captures new audio information using the microphone. The terminal packages the feedback as evaluation information and comment information, adds identifiers of the related ideas and session, and transmits this feedback information to the server. The input of Step 9 is the display data and audio output data from Step 8, and the output of Step 9 is feedback information transmitted from the terminal to the server.

### Step 10:

The server processes the feedback information and updates the storage information. The server stores ratings and selections as evaluation records and stores text comments as comment records in the feedback table, each linked to corresponding idea identifiers and the session identifier. If feedback is provided as audio, the server applies the speech recognition process to obtain character information from the audio and stores the transcribed feedback text. The server computes aggregate measures such as average rating per idea and identifies frequently occurring feedback terms. The server updates association records to link feedback entries to the idea information and related expressions that produced those ideas. The input of Step 10 is the feedback information from Step 9, and the output of Step 10 is updated storage information including new feedback records and association records.

### Step 11:

The server generates refinement prompt sentences for the generative AI model using the stored feedback information and the existing idea information. The server retrieves an idea record and its associated feedback entries, constructs an instruction that specifies refinement of the idea according to the feedback, and embeds the original idea text and a summary of feedback into the prompt. The server creates a prompt sentence such as: “You are refining product ideas based on user feedback. Original idea: ‘ . . . ’ User feedback:”‘. . . ’ Task: Rewrite and extend the original idea . . . ” The server tokenizes this refinement prompt and prepares it as input to the generative AI model. The input of Step 11 is a combination of idea information and feedback information from the storage information, and the output of Step 11 is a tokenized refinement prompt sentence.

### Step 12:

The server executes the generative AI model with the refinement prompt sentence to generate refined idea information and updates the idea records. The server provides the tokenized refinement prompt to the generative AI model, receives generated text describing revised titles and descriptions, and parses the text into structured fields. The server creates new idea records for the refined ideas, sets parent identifiers to reference the original ideas, and writes the records into the ideas table. The server may also adjust scoring values for related expressions based on which refined ideas receive positive feedback in subsequent interactions. The input of Step 12 is the tokenized refinement prompt from Step 11, and the output of Step 12 is newly generated refined idea information stored and linked in the storage information.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In large-scale industrial environments, such as production facilities and other complex workplaces, improvement activities increasingly rely on digital tools to collect ideas, analyze discussions, and generate concrete proposals. However, conventional computer-implemented brainstorming and requirements-definition systems suffer from several technical limitations.

First, existing systems generally record audio or text separately and require human operators to manually transcribe, clean, categorize, and summarize utterances. This causes high latency and inconsistency in the downstream processing. From a computer-technology standpoint, this results in inefficient utilization of processing resources, because the same or similar raw discussion data must be repeatedly processed by different heterogeneous applications without an integrated pipeline.

Second, when large-scale language models or other generative AI models are used, conventional systems typically provide static prompt sentences that are crafted manually or only loosely derived from past data. Such systems do not tightly couple the upstream acquisition and structuring of utterances with the downstream generation of prompts. As a result, the generative AI model often receives incomplete or noisy context, which leads to suboptimal idea generation and requires additional manual editing. This degrades the effectiveness and technical performance of the overall computer system, because multiple cycles of user interaction are needed to refine the output.

Third, conventional idea-management tools store generated ideas as unstructured text that is not directly suitable for automatic downstream processing such as document generation, visualization, or design support. In particular, prior systems do not automatically convert free-form ideas into structured data elements (such as objectives, procedures, resources, and effects) that can be programmatically consumed to generate specification documents, concept documents, images, drawings, or prototype data. This lack of structure complicates integration with other computer-implemented tools and prevents automated, repeatable workflows.

Fourth, feedback from users is typically collected in an ad-hoc manner, and is not technically integrated into the data pipeline that governs subsequent prompt construction for the generative AI model. The system therefore cannot systematically adjust the generation behavior based on explicit user approvals, rejections, or constraints. This causes the computing system to repeatedly produce ideas that are misaligned with actual requirements, resulting in unnecessary computational cycles and user corrections.

Accordingly, there is a need for a computer-implemented system that: (i) captures and transforms participants' utterances into cleaned, topic-organized text in an automated and integrated manner; (ii) automatically constructs and updates prompt sentences for a generative AI model based on that text and on historical feedback; (iii) converts the generated ideas into structured improvement information that can be programmatically processed; and (iv) uses such structured information to automatically generate machine-readable and human-readable artifacts, including specification documents, concept documents, images, drawings, and prototype data. By addressing these issues at the system and data-pipeline level, the invention improves the operation and technical functionality of computers used for idea generation, requirements management, and design support.

The specific processing by the specific processing unit 290 of the data processing device 12 in Application Example 1 is realized by the following means.

The present invention provides a server comprising a processor and a memory storing instructions which, when executed by the processor, cause the processor to acquire utterances of participants from an acoustic input device connected to a plurality of information processing devices, store the utterances as acoustic information associated with time information and identification information, perform acoustic recognition processing on the acoustic information to convert the utterances into character information indicating utterance content, remove unnecessary information from the character information, and organize the character information as text information classified by topic; generate a prompt sentence including the organized text information, input the prompt sentence to a generative AI model including a large-scale generative model, and cause the generative AI model to output related terms regarding work efficiency improvement and new ideas based on the related terms; analyze the new ideas output from the generative AI model, convert the new ideas into structured improvement information including an objective, operation procedure, resource information, and effect information, and edit the structured improvement information into display information including at least one of a document and an image; transmit the display information to the plurality of information processing devices, acquire feedback information through viewing and selection of the display information by the participants, and reflect the feedback information in the prompt sentence input to the generative AI model so as to iteratively improve generation processing of the new ideas; and further, based on the feedback information and the structured improvement information, automatically generate at least one of a specification document and a concept document including requirement items, constraint conditions, and execution procedures regarding work improvement, and, based on the specification document or the concept document and the structured improvement information, generate drawing data or prototype data indicating at least one of process layout, apparatus configuration, and prototype shape by performing at least one of image generation processing and design processing. This enables the computer system to implement an integrated, feedback-driven processing pipeline in which raw acoustic input is automatically transformed into cleaned, structured data, used to construct adaptive prompt sentences for a generative AI model, and further used to programmatically generate machine-usable and human-usable artifacts, thereby improving the efficiency, reliability, and technical performance of computer-implemented brainstorming, requirements definition, and design support operations.

The term “processor” refers to one or more hardware-based processing units, such as a central processing unit or a graphics processing unit, and any associated control logic configured to execute instructions to perform the functions described in the present specification.

The term “memory” refers to one or more computer-readable storage media, such as volatile memory or non-volatile memory, configured to store instructions and data for access by a processor.

The term “information processing device” refers to an electronic apparatus including at least a processor, a memory, and a communication interface, configured to exchange data with the server and to present information to a user.

The term “acoustic input device” refers to a hardware input component, such as a microphone or an array of microphones, configured to capture sound waves and convert the sound waves into electrical signals suitable for processing as acoustic information.

The term “acoustic information” refers to digital data representing sound, including at least sampled and quantized audio signals derived from utterances of one or more participants and optionally including associated metadata.

The term “time information” refers to data indicating a temporal attribute of acoustic information, such as a timestamp, time interval, or sequence order, which allows the acoustic information to be arranged along a time axis.

The term “identification information” refers to data that uniquely or semi-uniquely associates acoustic information or text information with a participant, device, location, session, or other entity.

The term “acoustic recognition processing” refers to computerized analysis of acoustic information using one or more algorithms, such as speech recognition algorithms, to convert the acoustic information into character-based data representing recognized utterance content.

The term “character information” refers to digital data composed of text characters representing words, phrases, or sentences corresponding to the content of recognized utterances.

The term “unnecessary information” refers to portions of character information that are not needed for downstream processing, such as fillers, repeated phrases, background noise annotations, or other elements that do not contribute to meaningful semantic analysis for idea generation.

The term “text information classified by topic” refers to character information that has been grouped, segmented, or labeled according to one or more topics, themes, or categories inferred from the content or context of the information.

The term “prompt sentence” refers to a text string or a set of text strings formatted as an instruction or query, constructed to be input to a generative AI model in order to elicit specific types of outputs, such as related terms or new ideas.

The term “generative AI model” refers to a computational model, such as a neural network-based language model, that is trained on large datasets and configured to generate new content, including text, based on input data such as a prompt sentence.

The term “large-scale generative model” refers to a generative AI model having a large number of parameters and trained on extensive datasets, enabling the model to perform complex natural language processing tasks and to generate contextually relevant outputs.

The term “related terms regarding work efficiency improvement” refers to words or expressions that the generative AI model identifies as being semantically associated with enhancement of operational efficiency or productivity in a work environment.

The term “new ideas” refers to proposals, suggestions, or concepts generated by the generative AI model that are not explicitly present in the input text information but are derived from it through learned associations or reasoning.

The term “structured improvement information” refers to data representing new ideas in a predefined organized format, including separate fields such as an objective, an operation procedure, resource information, and effect information.

The term “objective” refers to a description of a target state or goal that a generated idea seeks to achieve, such as increasing throughput or reducing error rate.

The term “operation procedure” refers to a sequence or set of steps, actions, or tasks that should be performed to implement a generated idea or improvement.

The term “resource information” refers to data identifying equipment, materials, personnel, software, or other assets required to implement a generated idea.

The term “effect information” refers to data describing expected or observed impacts of implementing a generated idea, such as changes in processing time, quality metrics, cost, or safety indicators.

The term “display information” refers to data prepared for output to a user interface, including at least one of formatted text, structured lists, diagrams, or images, enabling a user to view and evaluate generated ideas.

The term “document” refers to a collection of text and, optionally, figures or tables arranged according to a predefined layout, such as a specification document or a concept document, that can be stored, displayed, or printed by an information processing device.

The term “image” refers to visual data, such as a bitmap or vector representation, that can illustrate an idea, layout, configuration, or prototype in graphical form.

The term “feedback information” refers to data acquired from participants in response to display information, including approvals, rejections, selections, annotations, ratings, or comments regarding generated ideas.

The term “specification document” refers to a document that formally describes requirement items, constraint conditions, and execution procedures for implementing a work improvement, in a format suitable for use in planning or development processes.

The term “concept document” refers to a document that describes an overall idea, concept, or high-level plan for a work improvement, including at least an outline of objectives, features, and anticipated benefits.

The term “requirement items” refers to individual conditions or capabilities that a system, process, or improvement must satisfy, including functional requirements and non-functional requirements.

The term “constraint conditions” refers to limitations or restrictions that affect implementation of a work improvement, such as budget limits, physical space constraints, regulatory requirements, or technology constraints.

The term “execution procedures” refers to defined sequences of operations, tasks, or actions to be carried out in order to implement a work improvement in practice.

The term “drawing data” refers to digital data representing graphical layouts, diagrams, or design drawings of processes, apparatuses, or prototypes, readable by a computer-aided design system or a viewing application.

The term “prototype data” refers to digital data representing an initial or trial design of a product, component, or system, including geometry, structure, or configuration, that can be used to fabricate or simulate a prototype.

The term “process layout” refers to an arrangement of processing steps, equipment, workstations, or material flows within a work environment or production line.

The term “apparatus configuration” refers to the structural and functional arrangement of devices, components, or subsystems used to carry out a particular process or work improvement.

The term “prototype shape” refers to the geometric form, dimensions, or external contour of a prototype represented in drawing data or prototype data.

The term “image generation processing” refers to computational processing that creates image data from input data, such as text-based descriptions or structured improvement information, using algorithmic or model-based techniques.

The term “design processing” refers to computational processing that generates or modifies structural or layout data, such as drawing data or prototype data, based on design rules, input requirements, or structured improvement information.

The term “plurality” refers to two or more of the referenced elements, unless a different number is explicitly specified.

In one embodiment, a server cooperates with one or more terminals to implement the claimed system. The server includes at least one processor, a main memory, a non-volatile storage device, and a network interface. The server operates, for example, under a general-purpose operating system and executes software components including an audio acquisition module, a speech recognition interface module, a text processing module, a prompt generation module, a generative AI interaction module, an idea structuring module, a document generation module, an image and design generation module, and a feedback management module. The terminals each include a processor, a memory, a display, an input interface, and a communication interface, and execute a user interface application that communicates with the server over a network.

The server uses an acoustic input device such as a microphone or microphone array mounted on industrial equipment, robots, or fixed points in a factory environment. The server samples audio signals at a defined sampling frequency and bit depth, for example, 16 kHz and 16-bit linear PCM, and stores the sampled data as acoustic information in a circular buffer or time-stamped sequence of frames. The server associates each frame with time information (for example, a monotonically increasing timestamp) and identification information (for example, device identifier, location identifier, and optional speaker identifier if available from an upstream component). By structuring the audio as time-ordered frames with metadata, the server enables deterministic and reproducible re-processing, which improves traceability and error analysis compared to systems that store only raw audio streams.

The server invokes a speech recognition service using a client library executed in a runtime environment such as a Python interpreter. The server converts the acoustic information frames into a suitable audio file or byte stream format (for example, linear PCM or compressed lossless format) and sends the audio to a speech recognition engine. The speech recognition engine can be implemented by a network-accessible service or an on-premises module; in either case, the engine applies an acoustic model and a language model to map input acoustic features (such as Mel-frequency cepstral coefficients or log-Mel filterbank energies) to corresponding character sequences. In some implementations, the acoustic model is a deep neural network such as a recurrent neural network, a time-delay neural network, or a transformer encoder, trained with a sequence-to-sequence loss function (for example, connectionist temporal classification or attention-based cross-entropy). The server receives character information in the form of recognized text segments and their confidence scores, and stores them as a sequence aligned with the time information and identification information.

The server executes the text processing module to remove unnecessary information from the character information and to organize the character information as text information classified by topic. The server applies deterministic rules, such as regular expressions, to delete filler phrases, repeated interjections, or machine noise annotations. The server further segments the character information into candidate sentences or clauses using punctuation marks, prosodic cues derived from the time alignment, and language-specific sentence boundary detection rules. The server then computes topic labels by applying a keyword-based classifier or a vector-space similarity algorithm. In one embodiment, the server represents each sentence as a numerical feature vector using word embeddings or contextual embeddings derived from a transformer encoder. The server clusters these vectors using a clustering algorithm such as k-means or hierarchical clustering and assigns topic identifiers to each cluster. The resulting data structure is a set of text segments, each associated with a topic identifier, time range, and source identification.

The server generates a prompt sentence by combining one or more topic-specific text segments into a single text block and embedding the text block into a predefined template.

The server maintains different templates for different purposes, such as initial brainstorming, constraint-aware refinement, or feasibility evaluation. For example, the server can generate the following prompt sentence for a generative AI model:

“Workers are discussing how to increase the speed of the production line. They also mention that the manual quality check step has become a bottleneck and that they are considering automating the quality inspection. Based on this discussion, please generate several concrete ideas that combine higher line speed, automated quality inspection, and improved overall work efficiency in the factory.”

In another example, the server generates a prompt sentence that incorporates historical feedback:

“In previous sessions, supervisors rejected ideas requiring large capital investment and preferred low-cost, incremental improvements. Considering the following discussion about line speed and quality automation, please propose new ideas that minimize initial investment and can be implemented with existing equipment where possible.”

The server transmits the prompt sentence to a generative AI model through a generative AI interaction module. The generative AI model is implemented, for example, as a large-scale transformer-based language model having multiple encoder-decoder layers or decoder-only layers. The model includes an embedding layer that maps tokens to high-dimensional vectors, a stack of attention layers that compute self-attention and, where used, cross-attention over sequences, and a final linear layer with a softmax function to produce probability distributions over vocabulary tokens. The model is trained on large corpora using a next-token prediction objective or a masked-token prediction objective, with an optimization algorithm such as stochastic gradient descent or Adam, and a loss function such as cross-entropy over token sequences.

In this embodiment, the server does not merely rely on generic model behavior but configures the input and post-processing to improve the technical performance of the overall system.

The server normalizes the prompt sentence into token sequences, adjusts generation parameters such as maximum token length, temperature, and top-k or nucleus sampling cutoff, and enforces constraints on the output format by including format instructions in the prompt sentence. For example, the server may instruct the model to output ideas as numbered bullet points, each containing a brief title and a short description. This structured output reduces the computational burden on downstream parsing components and improves the reliability of automatic extraction of structured improvement information.

The server receives the generated text as new ideas and analyzes the text using the idea structuring module. The server converts each idea into structured improvement information by parsing specific fields. In one embodiment, the server applies rule-based extraction in combination with shallow natural language analysis. The server identifies pattern markers such as “objective:”, “steps:”, “resources:”, and “effects:” if present; when such markers are not explicitly present, the server classifies sentences using a sentence-level classifier trained to assign labels “objective”, “procedure step”, “resource”, or “effect” to each sentence. The classifier can be implemented using a small neural network, such as a bi-directional recurrent network or a fine-tuned transformer encoder, trained on annotated examples. By using such a structured extraction pipeline, the server produces improvement records in a normalized form, for example, as records having fields for an objective description, a list of operation procedures, a list of required resources, and a set of expected effect metrics.

The server generates one or more documents based on the structured improvement information and the feedback information acquired from terminals. The server composes specification documents and concept documents by inserting structured improvement information into predefined sectioned layouts, for example, background, objective, requirements, constraints, procedures, and expected effects. The server writes the documents in a markup format or a document format that can be rendered by standard office applications. The server can generate different document types from the same underlying structured improvement information. For instance, a specification document can include detailed constraint conditions and acceptance criteria, whereas a concept document can emphasize the overall idea and anticipated benefits.

The server can also generate images or design-related data. In one embodiment, the server uses an image generation model to create conceptual images depicting a process layout or apparatus configuration. The server constructs a text description for the image model based on structured improvement information, for example:

“An industrial production line with a high-speed conveyor, multiple cameras mounted above the line, and an automatic rejection lane controlled by an AI-based quality inspection system, schematic style.”

The server sends this description to an image generation model such as a diffusion-based or generative adversarial network model. The image generation model internally processes the description by encoding the text into an embedding space and performing iterative denoising or generative steps to create an image. The server receives the synthesized image, associates it with the corresponding improvement record, and stores it for display.

In another embodiment, the server interfaces with a design processing module or a computer-aided design engine to generate drawing data or prototype data. The server converts structured improvement information into geometric and topological specifications, such as relative positions of sensors, conveyor width, and path of material flow, and sends these specifications to a CAD kernel that generates layout diagrams or three-dimensional models.

In this way, the server creates machine-readable design data that can be used for simulation or fabrication processes, thereby linking the abstract improvement ideas to concrete technical artifacts.

The server communicates with terminals through a network using a defined application programming interface. The server transmits display information, including titles, structured fields, documents, and images, to the terminals in a format suitable for rendering, such as structured text with references to images and downloadable documents. The terminals display lists of ideas, detailed views, and visual representations, and accept user selections, comments, approvals, and rejections as feedback information. The terminals send the feedback information back to the server, where it is stored in a feedback repository and associated with corresponding improvement records and prompt sentences.

The server utilizes the feedback information to adjust subsequent prompt sentence generation and downstream processing. For example, when the feedback information indicates that users frequently reject ideas due to high cost or excessive complexity, the server embeds additional constraints into future prompt sentences, such as “limit proposed changes to existing equipment where possible” or “avoid solutions that require new heavily customized hardware.” The server may also adjust numerical parameters used to filter ideas, such as discarding ideas whose estimated resource requirements exceed a stored threshold. By feeding such structured feedback into the prompt sentence and algorithmic filters, the server causes the generative AI model and downstream modules to converge more quickly towards acceptable solutions, thereby reducing the number of generations and the computational load.

The server implements these operations using specific data structures and algorithmic flows rather than abstract conceptual steps. For example, the server maintains:
An audio frame buffer storing fixed-length audio blocks with timestamps and identifiers.
A transcript log storing recognized utterances with time ranges, confidence scores, and initial topic labels.
A topic index mapping topic identifiers to lists of utterance identifiers.
An idea record store storing structured improvement information, including normalized fields and references to documents and design data.
A feedback database storing user responses with links to idea records and prompt identifiers.

By organizing data in these explicit structures, the server can execute efficient queries, such as retrieving all utterances related to a specific topic within a given time range or aggregating feedback by topic and constraint type. These query capabilities enable the server to construct more accurate and context-sensitive prompt sentences, contributing to improved generation quality and reduced processing time.

From a technical perspective, the server improves computer technology in several ways.

First, the server integrates audio acquisition, speech recognition, natural language processing, generative AI interaction, and document and design generation into a unified pipeline with explicit data structures and feedback loops. This integration reduces redundant processing, minimizes data conversion overhead, and enables re-use of intermediate representations across modules. Second, the server uses topic-based classification and structured extraction to constrain and normalize the input and output of the generative AI model, thereby reducing noise and improving the precision of generated ideas. Third, the server actively incorporates user feedback into the generation process through modifications of prompt sentences and filtering criteria, which leads to fewer non-viable ideas and fewer required generation cycles. These improvements manifest as faster end-to-end processing, lower computational resource consumption, and improved consistency of generated results.

Additionally, the server enables technical improvements in real-world environments. When the system is deployed in a factory, the server uses audio captured from actual production lines and produces proposals that link directly to process layout, apparatus configuration, and prototype shape. The server, by generating drawing data and prototype data, can control downstream design tools or simulation engines, which in turn affect physical modifications to equipment and workflows. This chain from acoustic input to machine-readable design output constitutes more than a business process; it is a concrete technical mechanism that changes how computers process audio, text, and design data to control or influence physical systems.

The server does not merely replace a human facilitator with an automated script. The server implements specific, non-conventional rule sets and model interactions. For example, the server can apply a hybrid rule-based and model-based scoring function to rank generated ideas, combining pattern matches (such as presence of certain mandatory components or avoidance of prohibited configurations) with semantic similarity scores derived from embeddings. The server may also perform data augmentation on past transcripts, such as paraphrasing or splitting and recombining utterances, to generate more diverse yet controlled context fragments for prompt sentences. These processing techniques differ from manual brainstorming or simple document editing and are tailored to exploit the capabilities of large-scale generative models in a structured and technically optimized manner.

In a variant embodiment, the server can employ a locally deployed generative AI model instead of an external service. In such a case, the server stores model parameters in local memory, loads them into the processor or an accelerator device, and executes forward-pass computations directly. The model may be trained or fine-tuned on domain-specific corpora using supervised or reinforcement learning. The server can compute gradients based on a loss function combining language modeling loss and task-specific penalties, and update model weights using an optimization algorithm. While full training may be performed offline, fine-tuning or adapter training can be performed periodically using accumulated transcripts and feedback, thereby adapting the generative AI model to the specific factory or organizational environment. This configuration further enhances response quality and reduces dependency on external communications, thus lowering network load and latency.

The terminals provide a user interface that is designed to cooperate with the server's data structures. The terminals request ideas by topic or time range, render structured fields in dedicated sections, allow the user to expand or collapse procedure steps, and present links to documents and images. The terminals also support offline caching of display information and deferred transmission of feedback information when network connectivity is intermittent. By structuring communication as compact representations of structured data and feedback flags rather than large unstructured text blocks, the system reduces communication load and improves robustness in constrained network conditions.

Through these embodiments and variations, the server, the terminals, and the users cooperate to transform raw acoustic discussions into structured, machine-usable improvement information and technical artifacts. The described architecture, data structures, and algorithmic flows provide sufficient detail for a person skilled in the art to implement the invention and demonstrate that the invention improves computer technology itself in terms of processing speed, reliability, data management, and integration with design and control systems, rather than merely automating a human mental process.

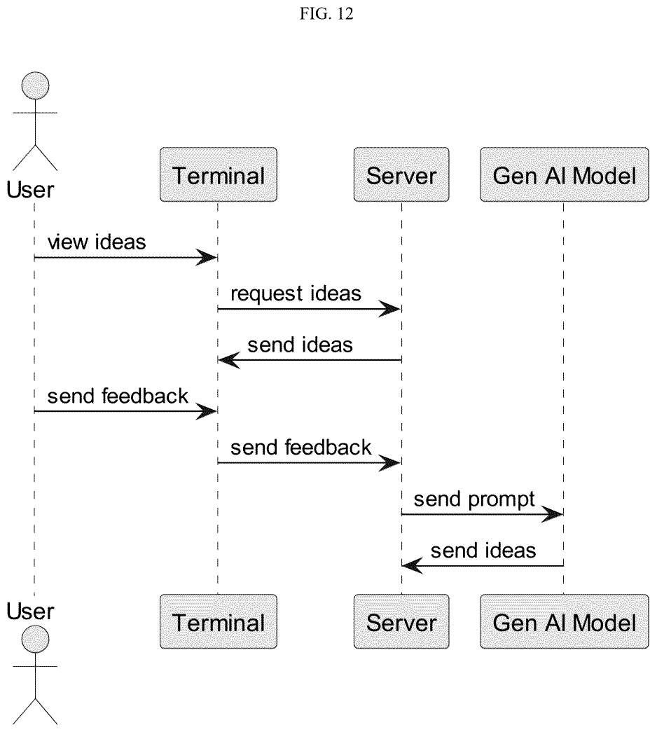

The following describes the processing flow using FIG. 12.

### Step 1:

The server acquires acoustic data from an acoustic input device.

The server receives analog sound signals from a microphone or microphone array mounted on equipment and converts the analog signals into digital samples with a defined sampling rate and bit depth. The input of this step is continuous analog sound produced by participants, and the output is a sequence of digital audio frames, each frame being tagged with time information and identification information such as device ID and location ID. The server performs analog-to-digital conversion and frames the sampled data into fixed-length buffers (for example, several hundred milliseconds), thereby generating acoustic information suitable for subsequent processing.

### Step 2:

The server stores and manages the acoustic information as time-aligned records.

The server writes the digital audio frames into an audio buffer or database table, associating each frame with its timestamp, identification information, and a session identifier. The input of this step is the sequence of tagged audio frames from Step 1, and the output is a structured audio record set organized by time and source. The server performs data structuring and indexing operations, such as creating indices on timestamps and device IDs, so that later modules can efficiently retrieve audio segments corresponding to specific time windows or participants.

### Step 3:

The server performs speech recognition to convert acoustic information into character information.

The server reads the stored audio frames for a selected time interval, concatenates them into an audio segment, and sends the segment to a speech recognition engine. The input of this step is one or more audio segments with associated metadata, and the output is character information representing recognized utterances together with confidence scores. The server applies feature extraction (for example, computing Mel-frequency cepstral coefficients) and invokes a neural speech recognizer that maps the acoustic features to text tokens using an acoustic model and a language model. The server then receives the recognized text and stores it as a transcript aligned with the original time information.

### Step 4:

The server cleans and normalizes the character information.

The server processes the transcript to remove unnecessary information such as filler words, repeated interjections, and explicit noise markers. The input of this step is raw character information including all recognized content from Step 3, and the output is cleaned character information in which non-essential phrases are removed or replaced by standardized tokens.

The server performs text normalization operations, including tokenization, stop-word filtering, regular expression replacement, and confidence-based pruning, so that the resulting text is more concise and suitable for topic analysis and prompt construction.

### Step 5:

The server segments and classifies the cleaned character information by topic.

The server divides the cleaned text into sentences or clauses and assigns topic labels to each segment based on content similarity. The input of this step is the cleaned character information from Step 4, and the output is text information classified by topic, where each segment is associated with a topic identifier and a time range. The server computes vector representations (embeddings) of each sentence, applies a clustering or classification algorithm to group similar content, and writes the resulting topic assignments into a topic index that maps topics to lists of utterance segments.

### Step 6:

The server selects topic-specific text segments and constructs a prompt sentence.

The server retrieves all text segments related to a selected topic, orders them by time, and concatenates them into a context block. The input of this step is topic-classified text information from Step 5 and a selected topic identifier, and the output is a prompt sentence or prompt text block for a generative AI model. The server embeds the context block into a template, for example:

“Workers are discussing how to increase the speed of the production line. They also mention that the manual quality check step has become a bottleneck and that they are considering automating the quality inspection. Based on this discussion, please generate several concrete ideas that combine higher line speed, automated quality inspection, and improved overall work efficiency in the factory.”

The server performs string formatting and template filling operations, thereby producing a coherent prompt sentence tailored to the current topic and constraints.

### Step 7:

The server transmits the prompt sentence to a generative AI model and obtains new ideas.

The server encodes the prompt sentence into tokens, sets generation parameters (such as maximum token length and sampling strategy), and sends a generation request to a generative AI model. The input of this step is the constructed prompt sentence from Step 6, and the output is generated text containing new ideas and related terms regarding work efficiency improvement. The server receives the generated output sequence from the model, decodes the tokens back into text, and stores the generated ideas along with the prompt identifier and topic identifier. The server thus performs a transformation from structured, topic-based input text into synthetic idea proposals.

### Step 8:

The server parses and structures the generated ideas into improvement records.

The server analyzes each generated idea text to identify its objective, operation procedure, resource requirements, and expected effects. The input of this step is the generated idea text from Step 7, and the output is structured improvement information stored as records with explicit fields. The server executes parsing and classification operations: it splits the generated text into sentences, applies rule-based patterns and trained classifiers to assign sentence-level labels (objective, step, resource, effect), and aggregates labeled sentences into structured fields. The server then writes the structured fields into an idea record store, producing machine-readable representations that can be used by downstream modules.

### Step 9:

The server generates documents and other display information from structured improvement records.

The server reads structured improvement information and composes human-readable documents such as specification documents and concept documents, and also prepares summaries for display. The input of this step is the structured improvement information from Step 8, and the output is display information including formatted text, document data, and references to visual content. The server performs document assembly operations by inserting field values into predefined section templates, generating headings and lists, and producing layout metadata. The server may also create short summaries and titles from the structured fields for use as overview elements in the terminal user interface.

### Step 10:

The server generates optional images or design data associated with the improvement records.

The server converts selected structured improvement information into textual descriptions for an image generation model or into parameter sets for a design module. The input of this step is structured improvement information from Step 8, and the output is image data or drawing/prototype data linked to the corresponding idea records. The server performs data mapping operations, such as translating resource and layout descriptions into spatial relationships, and invokes an image generator or design engine to synthesize visual representations or CAD-compatible layouts. The server stores the resulting images or design files and associates them with the idea record identifiers for later retrieval and display.

### Step 11:

The server assembles and transmits display information to the terminals.

The server aggregates titles, structured fields, document references, and image or design data into a response payload addressed to one or more terminals. The input of this step is the previously generated display information and associated media from Steps 9 and 10, and the output is a transmitted data packet containing all elements required for user presentation. The server serializes the data into a defined format, attaches necessary metadata such as creation time and topic, and sends the packet through a network interface to the terminals. The server thus performs data packaging and communication operations that make the structured improvement information and related artifacts available to the terminals.

### Step 12:

The terminal receives and renders the display information for the user.

The terminal downloads the data packet from the server, parses the structured content, and presents the improvement ideas on a display. The input of this step is the transmitted display information from Step 11, and the output is a visual user interface that shows lists of ideas, detailed descriptions, documents, and images. The terminal executes rendering operations, such as constructing list views from idea titles, generating detail screens from structured fields, and invoking document and image viewers to present supplementary materials. The terminal also prepares interactive elements, such as buttons or check boxes, to allow the user to provide feedback.

### Step 13:

The user reviews the presented ideas and provides feedback through the terminal.

The user reads titles, descriptions, and documents, and visually inspects images or design data on the terminal display. The input of this step is the rendered user interface from Step 12, and the output is feedback information including selections, approvals, rejections, comments, and priority indications. The user operates input devices such as a touch screen or keyboard to mark ideas as accepted, rejected, or pending, and optionally enters text comments explaining reasons or constraints. These user actions are translated by the terminal into structured feedback data that can be transmitted back to the server.

### Step 14:

The terminal collects and transmits the feedback information to the server.

The terminal packages the user's selections and comments into a feedback message that references the corresponding idea record identifiers and prompt identifiers. The input of this step is the raw interaction events and entered text from the user in Step 13, and the output is a structured feedback payload sent over the network to the server. The terminal executes data encoding operations, including validation of input fields and assignment of timestamps and user identifiers, and then sends the encoded feedback message via its communication interface.

### Step 15:

The server stores the feedback information and updates internal models and parameters.

The server receives the feedback payload from the terminal and writes the feedback into a feedback database linked to each idea record and prompt sentence. The input of this step is the structured feedback information from Step 14, and the output is updated feedback records and adjusted configuration for future prompt generation and idea filtering. The server executes database insertion and update operations, and then analyzes aggregated feedback over multiple sessions to derive constraints and preferences. The server incorporates these constraints and preferences into rule sets and templates used in Step 6 and into filtering criteria applied to outputs from Step 7, thereby modifying its subsequent behavior to reduce non-relevant ideas and improve alignment with user requirements.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In modern computer-assisted planning and design workflows, users often rely on generic text generation tools to create ideas and documents. However, conventional systems typically treat idea generation, idea organization, and document drafting as separate, loosely coupled operations. As a result, several technical problems arise in the operation of information processing apparatuses and networks.

First, a processor in a conventional system usually handles user-provided text or transcripts only as flat text data without structured semantic enrichment. The processor does not automatically segment generated text into discrete idea units, does not generate numeric semantic representations of those units, and does not perform robust machine-based categorization. Consequently, storage devices and memory subsystems maintain unstructured text that is difficult for the processor to search, filter, and reuse efficiently. This leads to increased processing time, higher memory usage, and repeated, redundant calls to external models, thereby degrading system throughput and responsiveness.

Second, while generative AI models can produce large volumes of text, conventional systems do not implement a feedback-aware processing loop tightly integrated with these models. Feedback from participants (for example, evaluations or correction instructions) is often handled outside of the core processing pipeline, such as through manual edits in separate applications. The processor therefore cannot systematically associate feedback information with specific idea units and their detailed explanations in storage. Because the processor lacks structured mappings between feedback and underlying idea data, subsequent idea generation or document generation processes cannot programmatically exploit prior feedback to improve output relevance and quality. This results in inefficient use of computational resources, repeated generation of low-quality or redundant ideas, and increased network and processor load due to unnecessary model invocations.

Third, document generation in conventional systems is generally performed as a post-processing step, often relying on manual operations or ad hoc scripts that are not tightly integrated with the generative AI pipeline. The processor typically generates raw text and then requires human operators to reorganize the text into requirements definition documents or concept documents following project-specific structures. This manual restructuring increases latency, introduces inconsistency in document formats, and prevents the processor from applying standardized templates and editing rules at scale. As a result, computer resources are not optimally utilized, and the generation of formal specification documents remains slow and error-prone.

Fourth, many conventional systems fail to exploit multi-stage prompting and internal prompt construction within the same processor-controlled pipeline. The generative AI model is generally provided with a single-layer prompt based on user input, and intermediate machine-generated artifacts (such as categorized ideas or detailed explanations) are not reused as structured internal prompts. This limits the processor's ability to build hierarchical, context-rich prompts that can guide the generative AI model more effectively. Consequently, the quality, consistency, and technical depth of generated ideas and documents are limited, and the processor cannot fully leverage hardware acceleration or caching mechanisms because intermediate results are not formally modeled or stored.

Thus, there is a need for an improved system and method in which a processor: (i) converts audio information into character information; (ii) uses generative AI models to generate multiple idea information items; (iii) segments, numerically represents, and categorizes those items; (iv) automatically constructs internal prompts to obtain structured detailed explanations; (v) integrates those explanations into standardized documents; and (vi) stores and reuses structured feedback mappings. Such a system would improve the operation of processors, memory, and networks by reducing redundant processing, enabling structured reuse of intermediate results, and systematically incorporating feedback into subsequent computing steps.

The specific processing by the specific processing unit 290 of the data processing device 12 in Example 2 is realized by the following means.

The present invention provides a server comprising a processor and a memory storing instructions that, when executed by the processor, cause the processor to sequentially acquire audio information of participants and convert the audio information into character information; to receive a prompt sentence from a user together with the character information as input information and to supply the input information to a generative AI model including a generative language model so as to generate, in a natural language, a plurality of idea information items related to the input information; to analyze the plurality of idea information items by using the generative AI model or a natural language processing program so as to perform phrase analysis and statistical processing and to split and extract the plurality of idea information items as individual idea information items; to numerically convert the individual idea information items by using a semantic representation vector generation model and a classification program and, based on a predetermined classification criterion, to organize the individual idea information items by category as functional classification information or application classification information; to automatically generate internal prompt sentences including the individual idea information items and category information thereof, to input the internal prompt sentences to the generative AI model, and to generate, for each of the individual idea information items, detailed explanation information including purpose information, function information, and usage scene information; to integrate the detailed explanation information in accordance with a predetermined document structure rule and to automatically generate, as a project start document, a requirements definition document or a concept document; to transmit the plurality of idea information items and the requirements definition document or the concept document to a display terminal, to present the plurality of idea information items and the requirements definition document or the concept document to participants, and to collect feedback information as evaluation information or correction instruction information; and to store, as storage information, a correspondence between the feedback information and the individual idea information items and the detailed explanation information and to reflect the stored correspondence in a subsequent idea generation process or document generation process. This enables improvement of computer functionality by structuring intermediate idea data and feedback mappings within the memory, reducing redundant processing by reusing categorized ideas and detailed explanations in later model invocations, and enhancing throughput and consistency of automatically generated requirements documents and concept documents through a processor-controlled, feedback-aware generative pipeline.

The term “audio information” refers to time-series data representing sound produced by one or more participants, including but not limited to spoken utterances, captured by an input device such as a microphone and processed in digital form by a processor.

The term “character information” refers to text data obtained by converting audio information into symbols or characters according to a language rule set, such as letters, numerals, and punctuation, which can be stored, searched, and processed by a computer.

The term “prompt sentence” refers to a text input provided by a user to instruct a generative AI model, the text input specifying at least a topic, request, or constraint used as a basis for generating natural language output.

The term “generative AI model” refers to a machine learning model configured to generate new data, including natural language sentences, based on input data, the machine learning model having been trained on a dataset and operating by estimating probability distributions over possible outputs.

The term “generative language model” refers to a type of generative AI model that processes sequences of tokens representing natural language and generates subsequent tokens to form coherent text based on learned language patterns.

The term “idea information” refers to natural language text representing a proposal, concept, feature, or solution element generated by a generative AI model in response to input information such as a prompt sentence and character information.

The term “plurality of idea information items” refers to two or more discrete instances of idea information, each instance being treated as a separate unit for analysis, categorization, and document generation.

The term “individual idea information item” refers to a single, segmented unit of idea information that has been split from a larger text and is handled independently by the processor for analysis, categorization, and explanation.

The term “natural language processing program” refers to software instructions executed by a processor to analyze, transform, or generate human language text, including operations such as tokenization, part-of-speech tagging, parsing, and named entity recognition.

The term “phrase analysis” refers to an operation in which a processor analyzes text to identify linguistic units, such as phrases, clauses, or keyword groups, in order to extract structural or semantic information from natural language text.

The term “statistical processing” refers to operations in which a processor applies quantitative methods, such as frequency counts, co-occurrence analysis, or probabilistic modeling, to text data in order to derive patterns or weights useful for classification or selection.

The term “semantic representation vector generation model” refers to a machine learning model configured to convert natural language text into numerical vectors in a latent space such that semantic similarity between texts is reflected by geometric relationships between the vectors.

The term “classification program” refers to software instructions executed by a processor to assign one or more category labels to input data, such as idea information, based on features including numerical vectors, keywords, or other extracted properties.

The term “functional classification information” refers to category information indicating functional aspects or roles of an individual idea information item, such as processing function, system capability, or operational behavior, assigned by a classification program.

The term “application classification information” refers to category information indicating usage fields, domains, or application scenarios of an individual idea information item, such as industry type, user group, or deployment context, assigned by a classification program.

The term “category information” refers to one or more labels or identifiers assigned to an individual idea information item indicating membership in functional or application classes determined by a classification process.

The term “internal prompt sentence” refers to a text sequence automatically generated by the processor, based on at least an individual idea information item and associated category information, for use as an input to a generative AI model in a subsequent processing stage.

The term “detailed explanation information” refers to structured or semi-structured text describing an individual idea information item with additional attributes such as purpose, required functions, usage scenes, or technical considerations.

The term “purpose information” refers to a subset of detailed explanation information that describes objectives, intended effects, or goals of an individual idea information item.

The term “function information” refers to a subset of detailed explanation information that describes operations, capabilities, or processing steps that a system or component should perform according to an individual idea information item.

The term “usage scene information” refers to a subset of detailed explanation information that describes contexts, environments, user interactions, or scenarios in which an individual idea information item is intended to be used.

The term “document structure rule” refers to a set of constraints or templates defining sections, headings, item order, and hierarchical relationships for organizing text into a standardized document format.

The term “project start document” refers to a document used in an early phase of a project, the document including high-level specifications, objectives, and conceptual descriptions that guide subsequent design and implementation.

The term “requirements definition document” refers to a project start document that formally describes functional and non-functional requirements, constraints, and interfaces of a system or service in a structured format.

The term “concept document” refers to a project start document that describes a problem, proposed solution concept, target users, and value proposition at a higher level of abstraction than a requirements definition document.

The term “display terminal” refers to an information processing device equipped with a display unit and a communication interface, configured to receive data from a server and present text, images, or documents to a user.

The term “feedback information” refers to data provided by participants, including evaluations, comments, correction instructions, or approval indications, concerning idea information, detailed explanation information, or generated documents.

The term “evaluation information” refers to a type of feedback information that expresses an assessment of quality, relevance, or priority of an individual idea information item or a generated document.

The term “correction instruction information” refers to a type of feedback information that instructs changes, additions, or deletions to be applied to an individual idea information item, detailed explanation information, or a generated document.

The term “storage information” refers to data held in a storage device, including at least associations between feedback information, idea information items, and detailed explanation information, used for subsequent processing.

The term “correspondence” refers to a stored relationship or mapping between two or more data elements, such as feedback information and a specific individual idea information item, enabling the processor to link and retrieve related data.

The term “subsequent idea generation process” refers to any later execution of processing steps in which a generative AI model generates new idea information items, the processing steps optionally using stored correspondences as input context.

The term “subsequent document generation process” refers to any later execution of processing steps in which the processor generates or updates a document, such as a requirements definition document or concept document, using previously stored correspondences and intermediate data.

The term “document template” refers to a predefined schema or pattern including section headings, item placeholders, and formatting rules used by the processor to generate a structured document from input text.

The term “editing rule” refers to a guideline or algorithm specifying how to arrange, merge, emphasize, or filter text when generating a formatted document from detailed explanation information.

The term “heading structure” refers to a hierarchical arrangement of section titles or headings assigned to parts of a document to clarify its organization.

The term “item structure” refers to an arrangement of sub-sections, bullet points, numbered lists, or data fields within a document, assigned to represent detailed elements of requirements or concepts.

The term “priority information” refers to metadata indicating the relative importance, urgency, or processing order of items or sections in a document.

The term “formalized specification document” refers to a document that conforms to a document template and editing rules, and that contains structured, machine-processable descriptions of requirements or specifications.

The term “image generation technology” refers to a technology that uses a computational model to generate image data from input information such as text descriptions or structured data.

The term “image generation model” refers to a machine learning model configured to output image data, including diagrams or renderings, based on input data such as text or vector representations.

The term “design image information” refers to image data representing structural or functional aspects of a system, such as configuration diagrams, architecture diagrams, or interface layouts.

The term “prototype image information” refers to image data representing preliminary visualizations of a system, such as mock-ups, trial designs, or early-stage appearance concepts.

The term “functional configuration diagram” refers to a graphical representation in which functional components of a system and relationships between the functional components are depicted.

The term “screen configuration diagram” refers to a graphical representation of user interface screens, including layouts of elements such as buttons, text fields, and menus.

The term “external prototype diagram” refers to a graphical representation showing the outer appearance or form factor of a product or system, such as device housing or physical layout.

The term “processor” refers to a hardware computing unit, such as a central processing unit or an accelerator, configured to execute instructions for performing data processing operations described in the system.

The term “memory” refers to a storage medium, such as volatile memory or non-volatile memory, configured to store instructions and data for use by the processor in executing the operations of the system.

In one embodiment, a server cooperates with one or more terminals to implement the claimed system. The server includes at least one processor, a memory, a non-volatile storage device, and a network interface. The terminal includes at least one processor, a memory, a display unit, an input unit such as a keyboard or touch panel, an audio input unit such as a microphone, and a communication interface. The server and the terminal communicate via a data network using a communication protocol such as HTTP over TLS.

The server executes an operating system such as a general-purpose server operating system and runs application software including a web application framework, an application programming interface layer, and a set of machine learning libraries. The server uses software components corresponding to frameworks such as a web application framework, a numerical computation library, and a machine learning library. The server further uses a natural language processing library corresponding to a tokenization and parsing library and a sentence embedding library. The server stores data in a relational database management system and, in some embodiments, in a vector database or a search engine.

The server executes a generative AI model that is implemented as a neural network-based generative language model. In one embodiment, the generative AI model has a transformer architecture including a plurality of encoder-decoder or decoder-only layers, each layer including multi-head self-attention mechanisms, feed-forward sublayers, and normalization sublayers. The server stores weight parameters of the generative AI model in the memory and loads the weight parameters into a hardware accelerator such as a graphics processing unit.

The server performs matrix multiplication, attention score computation, and non-linear activation operations using hardware-accelerated linear algebra functions.

The server represents each token in a prompt sentence and in intermediate text as an embedding vector. The server computes attention scores using scaled dot products between query, key, and value vectors in the transformer layers. The server applies a softmax function to normalize attention scores and generates context vectors as weighted sums of value vectors. The server applies a cross-entropy loss function during training of the generative AI model and updates the weight parameters using a gradient descent-based optimizer such as a stochastic gradient-based optimizer. The server may apply data augmentation to training data by adding noise, paraphrasing sentences, or varying sentence order to improve model robustness.

The server uses a separate semantic representation vector generation model, such as a sentence embedding model based on a transformer network with pooling, to convert an individual idea information item into a fixed-length semantic vector. The server applies a pooling operation such as mean pooling or max pooling over token embeddings to obtain the fixed-length vector. The server deploys this model on the same hardware accelerator as the generative AI model or on a central processing unit, depending on resource allocation. The server stores the resulting vectors in a data structure such as an array of floating-point numbers in the memory and optionally in a persistent vector store.

The server executes a classification program that maps each semantic vector to one or more category labels. In one embodiment, the server uses a neural network classifier implemented as a multi-layer perceptron with one or more hidden layers and a softmax output layer. The server uses the semantic vector as input features and computes class probabilities corresponding to functional classification information and application classification information. The server selects a category label for each idea by applying a threshold to the class probabilities or by selecting the label with a maximum probability. In another embodiment, the server uses a rule-based classifier that inspects keyword occurrences, dependency parse structures, or named entities extracted by the natural language processing library to assign categories according to predefined rules.

The server constructs internal prompt sentences for the generative AI model by combining an individual idea information item with its category information and with a template stored in the memory. The server stores the template as a text pattern including placeholders for idea text and category labels. The server replaces the placeholders with concrete text and generates an internal prompt sentence such as:

“You are a system design assistant.

Here is an idea:

Cloud-based speech recognition service supporting multiple languages for call centers.

Categories: Cloud Architecture, Multilingual Processing, Integration.

Based on this idea, generate a detailed explanation including:
1. Purpose of the idea
2. Required functions
3. Expected usage scenarios
4. Technical considerations.”

The server then feeds the internal prompt sentence to the generative AI model. The generative AI model processes the tokenized internal prompt, attends over the context tokens, and generates new tokens representing detailed explanation information. The server decodes the generated tokens into character information and segments the output into purpose information, function information, and usage scene information based on explicit section headers or pattern matching using regular expressions. The server stores each segment in structured fields within the database, such as columns for purpose text, function text, and scenario text.

The server generates a requirements definition document or a concept document by retrieving a set of individual idea information items, their category information, and their detailed explanation information from the database. The server applies a document structure rule, which is stored in the memory as a template specifying sections such as “Overview,” “Scope,” “Functional Requirements,” “Non-Functional Requirements,” and “Constraints.” The server organizes ideas into these sections according to their categories. For example, ideas categorized as performance or scalability are placed under a non-functional requirements section, while ideas categorized as core functions are placed under a functional requirements section. The server constructs a document by concatenating section headers and the associated text segments in a predetermined order.

The server may refine the constructed document by providing the assembled sections as a new prompt sentence to the generative AI model, using instructions such as: “Using the following ideas and explanations, create a formal requirements definition document. Maintain clear section titles: 1. Overview, 2. Scope, 3. Functional Requirements, 4. Non-Functional Requirements, 5. Constraints.”

The server then receives a refined document and applies editing rules to preserve numbering, headings, and paragraph boundaries. The server converts the document into a markup format such as HTML or a lightweight markup format and then uses a rendering tool to produce a portable document file. The server stores the document files in a non-volatile storage device and records file paths or identifiers in the database.

The server receives feedback information from participants through the terminal. The terminal displays a list of idea information items and associated detailed explanation information on a graphical user interface. The user operates the terminal to input evaluation information and correction instruction information. The terminal transmits this feedback information to the server along with identifiers of the related idea information items and documents. The server stores the feedback information as records linked by identifiers to the corresponding idea information items and detailed explanation information. The server may summarize feedback by calculating numeric scores or aggregating textual comments using natural language processing techniques.

The server uses the stored correspondence between feedback information and idea-related data as conditioning information for subsequent idea generation or document generation. For example, the server may analyze which categories or semantic vectors are associated with positive evaluations and adjust the selection of idea information items or adjust prompt sentences to emphasize similar characteristics. The server may convert feedback signals into weights used in a ranking algorithm that orders ideas before they are included in a document, thereby prioritizing ideas with high relevance scores.

In another embodiment, the server uses an image generation model to create design image information and prototype image information. The server may use a text-to-image generative model comprising a neural network architecture such as a diffusion model. The server encodes a textual description derived from a requirements definition document or a concept document into a latent representation using a text encoder. The server supplies this latent representation as a conditioning vector to an image generation network that iteratively denoises a random latent noise vector according to a learned denoising function. The server generates images representing functional configuration diagrams, screen configuration diagrams, or external prototype diagrams and stores the image data in an image file format.

The server improves computer technology by structuring uncontrolled free-text outputs from the generative AI model into machine-usable, semantically enriched data structures. By converting idea information into semantic vectors and category labels, the server enables efficient querying, caching, and re-use of ideas across sessions. This reduces redundant invocations of the generative AI model, thereby lowering computational load on the processor and hardware accelerator. The server can reuse previously generated detailed explanation information where semantic similarity between new and existing ideas exceeds a threshold, computed as a cosine similarity between semantic vectors. The server thus avoids regenerating highly similar explanations and reduces inference time and energy consumption.

The server also improves memory usage and data management. By storing idea information, category information, and feedback information as structured records instead of raw text blobs, the server enables indexed access patterns and selective retrieval. The server can fetch only those segments needed for a particular document section or for training, which reduces data transfer between storage and memory. This structured design improves cache locality and reduces disk I/O, which results in faster document generation and improved scalability when serving many users concurrently.

The server further improves processing accuracy by using feedback-correlated semantic vectors to guide subsequent prompt construction. Because the server maintains explicit mappings between feedback and idea vectors, the server can train an auxiliary model that predicts expected feedback based on semantic vectors. The server can then apply this auxiliary model during idea selection to filter out ideas predicted to receive low evaluations. This feedback-aware filtering reduces noise in idea sets and improves the precision of generated requirements and concept documents.

The server performs operations that extend beyond human mental steps or manual drafting.

The server carries out high-dimensional numerical operations, vector similarity computations, and neural network inference at a speed and scale that cannot be achieved by human operators. The server processes thousands of idea information items, computes embeddings, performs clustering or classification, and integrates them into documents in a manner that optimizes resource utilization on specific hardware components. The server uses batch processing and efficient matrix operations to exploit parallelism on hardware accelerators, thereby achieving improvements in throughput and latency that represent a technical improvement in the functioning of the computer system.

The AI-related processing in the server is not limited to substituting human judgment but instead uses specific, non-conventional processing rules. For example, the server uses a multi-stage prompting technique in which user-provided prompt sentences, internal prompt sentences based on semantic categories, and document-level prompts are generated and applied according to defined templates and control logic. The server determines an order of processing in which raw text is first segmented, then embedded, then categorized, and only then used to generate detailed explanations. This pipeline differs from conventional single-pass text generation and yields more structured, machine-processable outputs that improve the downstream operations of storage, retrieval, and document assembly.

In one alternative embodiment, the server deploys multiple generative AI models with different architectures or sizes. The server may use a smaller generative language model for initial idea generation to reduce latency and a larger model for detailed explanation generation where higher accuracy and nuance are required. The server may also use different semantic representation vector generation models optimized for different domains, such as technical systems or user interface design. The server can select a model variant based on resource conditions, project type, or user preferences. This adaptability contributes to improved computational efficiency and enhances responsiveness of the system.

In another embodiment, the server uses a hybrid classification method in which a rule-based classifier operates first to assign obvious categories based on well-defined keywords, and a neural network classifier handles ambiguous cases where keyword rules do not apply. The server uses control logic to route semantic vectors or text segments to one or both classifiers. This hybrid architecture reduces overall computational cost while maintaining high classification accuracy.

The terminal provides interfaces for audio input, text input, and result display. The user uses the terminal to capture audio information from participants during a session. The terminal sends encoded audio streams to the server, and the server applies an automatic speech recognition model to convert the audio information into character information. The automatic speech recognition model may be an acoustic model and language model combination running on the server or on a separate processing unit. The user also uses the terminal to provide a prompt sentence in plain text. Examples of prompt sentences include:

“Please propose a multilingual speech recognition system for call centers.”

“Generate innovative ideas for an AI-powered project management tool that automatically summarizes meeting notes and updates tasks.”

“Propose concepts for a mobile health application that supports remote monitoring of chronic disease patients and integrates with wearable devices.”

“Suggest several ideas for an educational platform that uses generative AI to create personalized learning paths for high school students.”

“Please generate ideas for an energy management system that optimizes power usage in smart buildings using sensor data and predictive analytics.”

The terminal receives and displays generated ideas, detailed explanations, and documents.

The user may scroll through sections, expand or collapse detail panels, and input feedback via rating widgets or comment fields. The terminal sends this feedback to the server as structured data containing identifiers, numeric scores, and textual comments. The user may also view design image information or prototype image information generated by the server, such as functional configuration diagrams or screen layouts, which the server transmits as image files.

In another embodiment, the server is integrated with external systems such as configuration management systems or project management systems. The server can output structured requirements in a machine-readable format that can be programmatically imported into those systems. By doing so, the server further reduces manual translation work and enables automated traceability between generated requirements and downstream implementation tasks.

Through these embodiments, the server, the terminal, and the user cooperate to realize a system in which generative AI models, semantic vector processing, and structured document generation are integrated into a feedback-aware pipeline. The technical structure of the models, data representations, and control flow results in improvements in processing speed, output accuracy, data management, and resource usage, thereby providing a specific improvement in the functioning of the computer system itself rather than merely automating a pre-existing manual process.

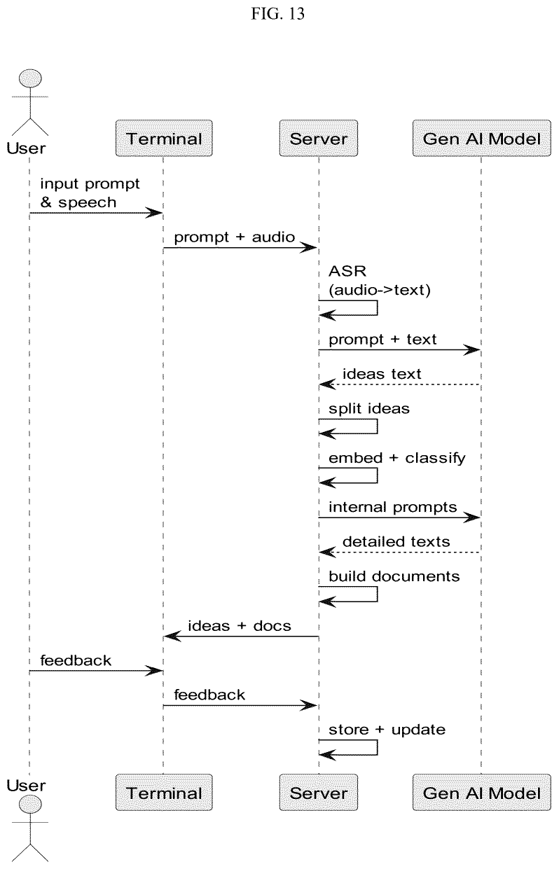

The following describes the processing flow using FIG. 13.

### Step 1:

The user operates the terminal to provide input. The user speaks into a microphone of the terminal and enters a prompt sentence into a text input field displayed on the terminal. The terminal receives audio information as a digital audio stream and receives text information as the prompt sentence. The terminal packages the audio information and the prompt sentence into a request data structure. As input, the terminal uses raw audio samples and a text string, and as output, the terminal generates a network message containing encoded audio data and the prompt sentence for transmission to the server.

### Step 2:

The terminal transmits the network message to the server. The terminal uses a communication interface to send the audio information and the prompt sentence to the server over a network using a protocol such as HTTPS. As input, the terminal uses the request data structure generated in Step 1, and as output, the terminal produces a formatted HTTP request containing headers and a body that includes the encoded audio data and the prompt sentence.

### Step 3:

The server receives and decodes the input data. The server uses a network interface to receive the HTTP request from the terminal and uses an application framework to parse the request.

As input, the server uses the encoded audio data and the prompt sentence. The server decodes the audio data into a waveform buffer and stores the prompt sentence as a character string in memory. As output, the server obtains a normalized audio buffer and a normalized prompt sentence ready for further processing.

### Step 4:

The server converts the audio information into character information. The server inputs the audio buffer into an automatic speech recognition module that includes an acoustic model and a language model. As input, the server uses the time-series audio samples from the microphone. The server performs feature extraction, such as computing Mel-frequency cepstral coefficients, then applies a neural network-based acoustic model to estimate phonetic probabilities, and applies a decoding algorithm with a language model to obtain text. As output, the server generates character information representing a transcription of participants' utterances.

### Step 5:

The server preprocesses the prompt sentence and the character information. The server receives the prompt sentence and the transcription text as input strings. The server normalizes the text by applying Unicode normalization, converting to a consistent case, and removing redundant whitespace. The server may tokenize the texts using a natural language processing library. As output, the server produces cleaned and tokenized prompt text and transcription text stored in data structures such as token lists or normalized strings.

### Step 6:

The server constructs an initial input for a generative AI model. The server takes the normalized prompt sentence and the transcription text as input. The server concatenates these texts according to a template, for example by appending the transcription as contextual information behind the prompt sentence. The server encodes the combined text into tokens according to the vocabulary of the generative language model. As output, the server produces a sequence of token identifiers representing the prompt sentence and contextual character information.

### Step 7:

The server generates multiple idea information items using a generative AI model. The server feeds the token sequence into a transformer-based generative language model stored in memory. As input, the server uses the encoded token sequence from Step 6. The server performs matrix multiplications, attention score computations, and non-linear activations in the model layers to compute probability distributions over next tokens. The server repeatedly samples or selects tokens based on these probabilities to generate natural language text. As output, the server obtains a generated text string that includes a plurality of idea information items, for example a list of proposals or concepts.

### Step 8:

The server splits the generated text into individual idea information items. The server receives the generated text string as input. The server applies parsing rules such as detecting line breaks, bullet symbols, or numbering patterns to identify boundaries between ideas. The server trims whitespace and discards empty elements. As output, the server creates a list or array of individual idea information items, each stored as a separate text string with an associated identifier.

### Step 9:

The server generates semantic representation vectors for each individual idea information item. The server uses the list of idea text strings as input. The server feeds each idea text into a semantic representation vector generation model, such as a transformer-based sentence embedding model, which tokenizes the text and computes token embeddings, then applies a pooling operation to obtain a fixed-length vector. As input, the server uses the tokenized idea text, and as output, the server generates a numerical vector (for example, a floating-point array) for each idea, stored in memory or a vector database.

### Step 10:

The server categorizes each individual idea information item. The server uses the semantic vectors or the raw idea text as input to a classification program. The server either passes the semantic vector to a neural network classifier or applies keyword and rule-based logic to the text. The server computes class scores and compares them to thresholds, or selects the highest scoring class, to determine functional classification information and application classification information. As output, the server assigns category labels to each idea and stores a mapping from idea identifiers to category information.

### Step 11:

The server constructs internal prompt sentences for detailed explanation generation. The server takes as input each individual idea information item and its associated category information. The server fills a template that includes fixed instruction text and placeholders for the idea text and category labels. The server concatenates these elements and formats them as a new internal prompt sentence. As output, the server generates a set of internal prompt sentences, each stored as a text string associated with an idea identifier.

### Step 12:

The server generates detailed explanation information using the generative AI model. The server provides each internal prompt sentence as input to the generative language model. The server encodes the text into tokens and processes the tokens through the transformer layers as in Step 7. The server generates output tokens that form detailed natural language explanations. As output, the server obtains, for each idea, a detailed explanation text that typically includes sections for purpose, functions, and usage scenes.

### Step 13:

The server segments each detailed explanation into structured components. The server uses the detailed explanation text for a single idea as input. The server searches for section markers or uses pattern matching to identify portions corresponding to purpose information, function information, and usage scene information. The server slices the text accordingly and stores each segment in separate fields. As output, the server creates a structured record for each idea, containing segmented detailed explanation information associated with the idea identifier.

### Step 14:

The server assembles a requirements definition document or a concept document. The server uses as input a set of structured idea records containing idea information, category information, and detailed explanation information. The server applies a document structure rule to decide which ideas belong to which sections and in what order. The server concatenates section headings and corresponding text segments into a continuous document string. As output, the server produces a draft requirements definition document or concept document in a markup or plain text format.

### Step 15:

The server optionally refines the assembled document using the generative AI model. The server uses the draft document as input and constructs a higher-level prompt sentence that includes the draft text and instructions for refinement. The server encodes and submits this prompt to the generative language model. The model generates a revised document with improved coherence and formatting. As output, the server obtains a refined document string that conforms to the intended structure and style.

### Step 16:

The server formats and stores the generated documents. The server takes the refined document text as input. The server converts the text into a structured format such as HTML or another markup form using a template engine, and then renders the markup into a final document file format such as a portable document file. The server writes the document file to non-volatile storage and records a reference such as a file path or identifier in the database. As output, the server produces a stored document object that can be retrieved and displayed later.

### Step 17:

The server transmits ideas, explanations, and document information to the terminal. The server uses as input the list of idea information items, the corresponding detailed explanations, and the references to the generated documents. The server packs this data into a response structure, serializes it into a network message, and sends it to the terminal over the network. As output, the server produces a response that contains structured data ready for presentation on the terminal.

### Step 18:

The terminal receives and displays the response to the user. The terminal uses the response message from the server as input. The terminal parses the structured data, generates user interface elements such as lists, expandable panels, and document links, and renders them on the display unit. As output, the terminal shows each idea, its category information, and its detailed explanation, and provides controls for the user to open or download the requirements definition document and the concept document.

### Step 19:

The user reviews the displayed content and provides feedback. The user examines the ideas and documents on the terminal screen as input information to human judgment. The user operates input elements, such as rating controls or comment fields, to generate feedback information including evaluations and correction instructions. As output, the user causes the terminal to create new feedback records associated with specific ideas and documents.

### Step 20:

The terminal sends the feedback information to the server. The terminal uses the feedback records as input and attaches identifiers of the related idea information items and documents.

The terminal constructs a network message containing the feedback data and transmits the message to the server over the network. As output, the terminal produces a feedback request that enables the server to update stored correspondences.

### Step 21:

The server stores and utilizes the feedback information. The server receives the feedback request as input. The server parses the feedback data, associates it with the corresponding idea identifiers and detailed explanation identifiers, and writes the feedback records into storage. The server may compute aggregate scores or update model-related metadata based on the feedback. As output, the server maintains updated storage information that can be consulted during subsequent idea generation and document generation to adjust prompt sentences, prioritize certain semantic vectors, or filter ideas, thereby improving the quality and efficiency of future processing.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented tools for requirements definition, brainstorming, and user interface prototyping typically treat speech recognition, natural-language understanding, document authoring, image generation, and emotion analysis as separate, loosely coupled subsystems. As a result, a processor often must execute multiple independent applications and manual integration steps to move from raw participant utterances to well-structured specifications and corresponding wireframes or prototypes. This fragmented workflow leads to several technical problems in computer operation.

First, existing systems usually capture participant utterances as unstructured text logs and do not maintain a unified utterance history that can be directly consumed by a generative model. Consequently, the processor cannot efficiently perform machine-driven extraction of related terms and concepts or organize new idea information in a structured form. This increases processing latency, requires repeated parsing of duplicated data, and leads to inconsistent internal state management.

Second, many systems rely on static, pre-defined templates for specification documents and image prompts. In such systems, the processor does not dynamically generate prompt sentences for generative models from current utterance history and specification content.

Therefore, the processor cannot automatically and coherently transform evolving idea information into specification document information and further into image-generation prompt sentences. This results in additional human intervention, multiple context switches between applications, and redundant data transformations, which collectively degrade machine efficiency and throughput.

Third, conventional tools do not integrate participant emotion signals-such as facial expression information and voice feature information-into the core generation loop of text and images. Emotion recognition, if present at all, is usually logged separately and is not used by the processor to adjust the behavior of generative models. As a result, the computing system cannot adapt the generation contents of prompt sentences, specification document information, or wireframe and prototype images in real time to the participant's emotional state. This limitation not only reduces the responsiveness of the human-computer interface, but also prevents the processor from optimizing resource usage by focusing generation on emotionally salient ideas and layouts.

Fourth, existing systems rarely record and exploit fine-grained input-output histories of generative models, including prompt sentences, response information, and generation condition information. Without such histories, the processor cannot learn from prior interactions to automatically refine future prompt sentences or propose effective prompt candidates. This leads to repeated trial-and-error prompt engineering by human users and unnecessary repeated invocations of remote models, which increase network traffic and computational overhead.

Accordingly, there is a need for an improved computer-implemented system in which a processor (i) unifies speech-to-text conversion and textual input into a persistent utterance history, (ii) automatically generates and refines prompt sentences for generative models to extract related terms and generate structured idea information, (iii) automatically constructs and iteratively updates specification document information and corresponding wireframe or prototype images, (iv) dynamically adapts these generated artifacts based on estimated emotional state information, and (v) records and analyzes generative model input-output histories to improve future prompt generation. Such a system would improve the functioning of the computer itself by reducing redundant parsing, minimizing manual coordination between heterogeneous tools, and enabling more efficient, context-aware invocation of generative models and image generation models.

The specific processing by the specific processing unit 290 of the data processing device 12 in Application Example 2 is realized by the following means.

The present invention provides a server comprising a processor configured to acquire utterances of a participant and sequentially convert audio information of the utterances into character information; to integrate the character information with character input information from the participant and store the integrated information as utterance history information; to generate a prompt sentence for a generative information-processing model on the basis of the utterance history information and use the prompt sentence to cause the generative information-processing model to extract related term information and concept information and to generate new idea information; to classify the generated idea information into groups according to a classification criterion and, for each group, to add summary information and function information so as to organize the idea information as structured idea information; to automatically create specification document information including overview information, functional requirement information, non-functional requirement information, usage situation information, and constraint condition information on the basis of the structured idea information; to extract operation screen information between a user and an apparatus and screen component information from the specification document information, to generate an image-generation prompt sentence on the basis of an extraction result, and to use the image-generation prompt sentence to cause an image-generating information-processing model to generate frame image information or prototype image information; to present the generated frame image information or prototype image information and the specification document information to the participant, to acquire evaluation information and correction instruction information from the participant, and to iteratively update the specification document information and the frame image information or the prototype image information; and to acquire facial expression information and voice feature information of the participant, to estimate emotional state information, and to dynamically adjust generation contents of at least one of the prompt sentence, the specification document information, and the frame image information or the prototype image information on the basis of the emotional state information. This enables the computer system to internally manage a unified utterance history, to automatically and coherently transform that history into structured specifications and corresponding visual designs, to reduce manual coordination between disparate applications, to adapt generative processing in real time based on emotional state, and to improve overall computational efficiency and responsiveness in generating and updating requirements documents and user-interface prototypes.

The term “utterance” refers to a segment of speech produced by a participant, represented as audio information before conversion and as character information after conversion.

The term “audio information” refers to time-series data representing sound signals captured from a participant, including but not limited to voice signals obtained via a microphone.

The term “character information” refers to digital data representing textual content obtained by converting audio information or by receiving text input from a participant.

The term “character input information” refers to textual data directly entered by a participant through an input device, such as a keyboard, touch screen, or pointing device, without passing through speech recognition.

The term “participant” refers to a user or operator who interacts with the system by providing utterances, character input information, evaluation information, or correction instruction information.

The term “utterance history information” refers to stored data that integrates multiple items of character information and character input information, optionally with associated metadata such as timestamps or speaker identifiers, representing a chronological record of participant communication.

The term “generative information-processing model” refers to a machine-implemented model that generates text or structured information based on input data, including a model that produces outputs in response to a prompt sentence.

The term “prompt sentence” refers to a sequence of character information that instructs a generative information-processing model or an image-generating information-processing model regarding a desired processing task or output format.

The term “related term information” refers to words, phrases, or technical terms that are identified by the generative information-processing model as being relevant to the utterance history information or to a given context.

The term “concept information” refers to higher-level semantic information that represents abstract ideas, themes, or topics derived from utterance history information or related term information.

The term “idea information” refers to data representing proposals, suggestions, or solutions generated by the generative information-processing model based on the utterance history information, related term information, or concept information.

The term “classification criterion” refers to a rule, parameter, or condition used to group idea information into multiple categories or groups, such as similarity of topic, function, or use case.

The term “structured idea information” refers to idea information that has been organized into groups according to at least one classification criterion, and to which summary information and function information have been added.

The term “summary information” refers to condensed textual data that describes the main content or purpose of one or more pieces of idea information.

The term “function information” refers to data describing operations, behaviors, or capabilities that are required or proposed in association with idea information or specification document information.

The term “specification document information” refers to structured textual data that defines system behavior and constraints, including overview information, functional requirement information, non-functional requirement information, usage situation information, and constraint condition information.

The term “overview information” refers to textual data that describes a general purpose, scope, or high-level description of a system or project.

The term “functional requirement information” refers to data specifying functions or operations that a system must perform, including inputs, outputs, and processing conditions.

The term “non-functional requirement information” refers to data specifying properties or quality attributes of a system other than functional behavior, such as performance, reliability, or usability.

The term “usage situation information” refers to data describing contexts, scenarios, or environments in which a system is expected to be used, including roles of users and typical workflows.

The term “constraint condition information” refers to data describing limitations or restrictions imposed on a system, such as technical, operational, regulatory, or resource constraints.

The term “operation screen information” refers to data describing user-facing display structures, including screens, views, or pages through which a user interacts with a system.

The term “screen component information” refers to data describing individual elements of an operation screen, such as buttons, input fields, menus, icons, panels, or layout structures.

The term “image-generation prompt sentence” refers to a prompt sentence specifically formatted to instruct an image-generating information-processing model to generate an image having specified content or style.

The term “image-generating information-processing model” refers to a machine-implemented model that generates image data from input data, including at least an image-generation prompt sentence.

The term “frame image information” refers to image data that visually represents a structural outline or wireframe of an operation screen, without requiring full design detail.

The term “prototype image information” refers to image data that visually represents a more detailed preliminary design or mock-up of an operation screen or system interface.

The term “evaluation information” refers to data representing a participant's assessment of specification document information, frame image information, or prototype image information, including ratings, comments, or approvals.

The term “correction instruction information” refers to data representing explicit instructions from a participant for modifying or updating specification document information, frame image information, or prototype image information.

The term “facial expression information” refers to data representing a participant's facial features or expressions captured by an imaging device and used for emotion estimation.

The term “voice feature information” refers to data representing acoustic characteristics of a participant's voice, such as pitch, intensity, or timbre, extracted from audio information for emotion estimation.

The term “emotional state information” refers to data indicating an estimated emotional condition of a participant, such as joy, confusion, frustration, or excitement, and optionally including a degree or intensity value.

The term “generation contents” refers to characteristics or parameters of data generated by a generative information-processing model or an image-generating information-processing model, including structure, emphasis, style, or selection of topics.

The term “input-output history” refers to stored data that records, for at least one generative information-processing model or image-generating information-processing model, a prompt sentence, response information, generation condition information, and associated metadata.

The term “response information” refers to data output by a generative information-processing model or an image-generating information-processing model in response to a prompt sentence

The term “generation condition information” refers to parameters or settings used when invoking a generative information-processing model or image-generating information-processing model, such as model type, resolution, temperature, or style options.

In one embodiment, a server executes a program that cooperatively uses a speech recognition engine, a generative AI model, an image-generating AI model, an emotion estimation engine, and a document generation module in order to transform participant utterances into structured specification documents and corresponding wireframe or prototype images.

The server comprises at least one processor, a memory storing program instructions and data structures, a network interface, and access to one or more external computation resources.

The terminal comprises an input/output device such as a smartphone, tablet, or personal computer including a microphone, a camera, a display, and user input devices. The user operates the terminal to interact with the system.

The server uses speech recognition software, such as a generic cloud-based speech-to-text service, to convert audio information into character information. The server uses a generative AI model, such as a transformer-based neural network language model, to generate and refine text and structured data in response to a prompt sentence. The server uses an image-generating AI model, such as a diffusion-based image synthesis neural network, to generate frame image information and prototype image information from an image-generation prompt sentence. The server optionally uses an emotion recognition engine, implemented as a convolutional and recurrent neural network, to infer emotional state information from facial expression information and voice feature information. The server uses a document generation module, such as an office-document library or an external document service, to create specification document information in a structured file format.

The server stores utterance history information, idea information, structured idea information, specification document information, image metadata, and emotion logs in one or more data repositories. In one embodiment, the server uses a relational database to store structured entities such as utterance records and documents, and uses an object storage system to store image files. Each data record includes identifiers, timestamps, and links to related entities to form a graph of relationships among utterances, ideas, requirements, and images.

The user operates the terminal to provide audio input through the microphone, text input through a keyboard or touch interface, and visual input through the camera. The terminal sends audio streams, character input information, and image frames to the server through a secure communication protocol. The terminal receives specification document information and image data from the server and renders them on the display. The terminal presents interactive controls for annotation, selection, and confirmation, and sends evaluation information and correction instruction information to the server.

The server represents utterance history information as a sequence of records, each record containing at least: a text field for character information, a timestamp field, a speaker identifier field, and optional emotion tags. By integrating character information obtained from speech recognition and character input information provided directly by the user, the server removes redundancy and maintains a single, consistent context that is directly consumable by the generative AI model. This unified structure reduces repeated parsing operations and reduces inconsistencies that could arise if speech-derived text and typed text were stored in separate subsystems.

The server uses the generative AI model to generate related term information, concept information, and idea information. In one embodiment, the generative AI model is a multi-layer transformer neural network with self-attention mechanisms, trained on a large corpus of text by minimizing a cross-entropy loss between predicted tokens and ground-truth tokens. During inference, the server sends a prompt sentence and a segment of utterance history information to the model. The prompt sentence may be, for example:

“From the following transcript, extract key topics and summarize the main ideas.”
or

“Using the following keywords, generate 10 novel ideas to improve system usability. Return them as a numbered list with brief descriptions.”
or

“Using the categorized ideas below, draft a requirements definition document. Include: 1) Overview, 2) Functional requirements, 3) Non-functional requirements, 4) Use cases, 5) Constraints.”

The server concatenates the prompt sentence and an excerpt of utterance history information into a single input sequence, performs tokenization into subword units, and feeds the resulting token IDs into the transformer. The model uses multi-head attention to relate each token to all other tokens in the context, and computes contextualized embeddings layer by layer. The model then computes probability distributions over the vocabulary for each next token and generates output text token by token. The server decodes the token sequence to character information and parses the result into related term information, concept information, and idea information according to predefined patterns or tags in the output.

The server organizes the generated idea information into structured idea information by applying a classification algorithm. In one embodiment, the server uses a hybrid approach: a rule-based classifier identifies simple categories based on keyword matches, and the generative AI model assigns or refines categories where the rule-based system is uncertain.

The server maintains a data structure in which each group of ideas is represented as a category node containing a category label, a list of idea identifiers, summary information, and function information. The server uses this data structure to support efficient retrieval and to avoid repeated re-classification. This structure also allows the server to compute similarity measures between categories, to merge overlapping groups, and to maintain a stable category hierarchy as new idea information is generated.

The server uses the structured idea information to generate specification document information. For this purpose, the server again uses the generative AI model with a more detailed prompt sentence. The server may use, for example:

“Using the structured idea information below, draft a detailed specification document.

Include sections for overview, functional requirements, non-functional requirements, usage situations, and constraints. Use clear headings and bullet lists.”

The server passes both the prompt sentence and a machine-readable representation of the structured idea information to the generative AI model. The server then converts the model output into a hierarchical document representation consisting of sections, subsections, and items. The server uses the document generation module to map this representation to a document file format such as a word-processing format or a markup format. The document generation module inserts headings, paragraphs, and lists according to the hierarchy. By generating specification document information directly from structured idea information in a programmatic manner, the server avoids manual transfer between unstructured notes and document templates and ensures internal consistency between ideas and formal requirements.

The server analyzes the specification document information to extract operation screen information and screen component information. In one embodiment, the server scans the document representation for patterns that indicate user interfaces, such as phrases containing “screen,” “page,” “form,” or specific UI element names like “search bar” or “button.” The server builds a UI specification structure where each screen is represented as a node containing attributes for name, purpose, data inputs, and outputs, and each screen component is represented as a child node with type, label, position hints, and constraints. The server uses this structure to produce an image-generation prompt sentence. For example, the server may generate:

“Generate a wireframe for a product search screen that includes a search bar at the top, filter options on the left, and a product list in the main area.”
or

“Generate a wireframe for a multilingual speech recognition interface with a large microphone button, a language selection control, and a translation result panel.”

The server sends this image-generation prompt sentence to the image-generating AI model.

In one embodiment, the image-generating AI model is implemented as a diffusion model that operates on image pixels or latent image features. The model is trained by gradually adding noise to training images and learning to reverse this noising process. During training, the model minimizes a mean-squared error between predicted noise and actual noise at multiple time steps, and updates network weights using stochastic gradient descent or a variant thereof. During inference, the server encodes the prompt sentence into an embedding using a language encoder, concatenates or conditions this embedding with random noise in the latent space, and iteratively denoises the latent representation using the learned network to produce a clean image. The server decodes the latent representation into pixel values and receives the resulting frame image information or prototype image information.

The server stores each generated image along with its prompt sentence, associated UI specification, and generation condition information, such as resolution, guidance strength, and random seed. This explicit linkage allows the server to reconstruct or modify the image by altering the prompt sentence or the conditions. It also allows the server to compare images generated under different settings and to select those that satisfy certain technical criteria, such as containing all required screen components.

The terminal receives the generated frame image information or prototype image information and the specification document information from the server. The terminal presents them on the display and provides interactive tools that allow the user to zoom, scroll, and annotate.

The user enters evaluation information such as “acceptable,” “needs more emphasis on error messages,” or “layout too dense,” and correction instruction information such as “add language selection dropdown above the microphone button” or “move filter panel to the top.”

The terminal sends this information to the server in a structured format.

The server incorporates the evaluation information and correction instruction information into the data structures used to maintain specification document information and UI specifications. The server may mark certain sections as accepted and others as needing revision. The server may adjust the structured idea information and regenerate affected sections of the specification document information using the generative AI model, with a prompt sentence such as:

“Revise the following functional requirement section to incorporate the user's correction: add a language selection dropdown above the microphone button on the main speech input screen.”

The server similarly updates the image-generation prompt sentence and invokes the image-generating AI model again to create a new version of the frame image information or prototype image information. By linking annotations directly to the underlying structured representations, the server avoids ad-hoc manual redrawing and keeps text and images synchronized.

The server optionally acquires facial expression information from image frames captured by the terminal camera and voice feature information extracted from audio streams. The server uses an emotion recognition engine to estimate emotional state information. In one embodiment, the emotion recognition engine includes a convolutional neural network trained on labeled facial expression data and a recurrent neural network trained on prosodic features of speech. The engine outputs probability distributions over emotion labels such as joy, confusion, frustration, or excitement. The server combines these probabilities with temporal smoothing rules to obtain a stable emotional state information value.

The server uses the emotional state information to dynamically adjust generation contents of at least one of the prompt sentence, the specification document information, and the frame image information or prototype image information. For example, when the server detects prolonged confusion during review of a particular requirement, the server may generate a prompt sentence:

“The user appears confused about the previous explanation. Re-explain the following requirement in simpler language and include two concrete examples.”

When the server detects strong positive emotion associated with discussion of a particular idea group, the server may modify the classification criterion so that these ideas receive higher priority values. The server then regenerates specification document information so that highly valued ideas appear earlier and are given more detailed descriptions. Similarly, when the server detects frustration while the user inspects a dense wireframe, the server may generate a new image-generation prompt sentence such as:

“Generate a minimal, calm wireframe using soft colors and fewer visible elements to reduce cognitive load, while preserving the same core functions.”

By feeding emotional state information into the core generation path as a parameter, the server changes not only surface presentation but also internal priorities and structural choices, thereby improving the adaptability of the computer-implemented system.

The server records input-output history for each invocation of the generative AI model and the image-generating AI model. Each history record contains the prompt sentence, the tokenized representation, model identifiers, generation condition information, and response information. The server stores these records in a dedicated log database indexed by task type, user context, and outcome rating. The server periodically analyzes the log database to identify prompt sentences that yield consistent and high-quality results. In one embodiment, the server applies clustering to the prompt sentences using vector representations obtained from a language embedding model and correlates clusters with outcome metrics such as user approval rate or number of subsequent corrections. The server uses this analysis to suggest or automatically construct future prompt sentences. For example, when a new session requires generation of a requirements document, the server can select a previously successful prompt structure and adapt only the embedded content (such as new keywords or idea lists), thus reducing trial-and-error. This re-use of optimized prompt patterns improves computational efficiency by decreasing the number of model invocations and by shortening the average length of prompts.

The described arrangement provides technical effects beyond mere automation of human drafting or drawing. By unifying speech-derived text and typed text into utterance history information with a specific, machine-optimized structure, the server eliminates redundant parsing passes and reduces memory footprint. By automatically transforming structured idea information into specification document information and further into image-generation prompt sentences, the server reduces serialization overhead and ensures that each transformation preserves and reuses the machine-readable structure. This direct data flow between modules improves cache locality and reduces the number of conversions between incompatible formats.

By integrating emotion-based adjustments into the generation loop, the server avoids generating large numbers of irrelevant or poorly received variants. The server uses estimated emotional state information as a filter and as a weighting factor for idea prioritization and screen layout selection. This reduces overall model calls and network traffic between the server and external AI services while focusing computation on content that is more likely to be accepted. In addition, by storing and analyzing input-output history with explicit prompt sentence, response information, and generation condition information, the server can optimize future parameter choices, such as sampling temperature or diffusion steps, to achieve similar or better quality with fewer computation steps, thereby reducing latency and energy consumption.

The generative AI model and the image-generating AI model operate with internal algorithms that differ from conventional rule-based or purely template-driven systems. The generative AI model uses multi-head self-attention to capture long-range dependencies in utterance history information and to adjust token probabilities based on global context, rather than applying a fixed set of if-then rules. The image-generating AI model uses iterative denoising in a latent space to synthesize visual structures conditioned on text embeddings, rather than composing static image templates. These architectures allow the server to compute non-trivial relationships between requirements and visual layouts, and to adaptively refine them based on feedback and emotion signals according to mathematically defined loss functions and optimization algorithms. Such processing is not a simple transposition of human cognitive steps into code, but constitutes an improvement to how the computer itself internally manages, transforms, and generates complex multi-modal data.

In another embodiment, the server may locally host a smaller generative AI model and image-generating AI model instead of accessing cloud-based services. In this case, the server may use quantization and pruning of neural network weights to reduce memory and computation requirements, while retaining sufficient accuracy for the target domain. The server may also adopt different network architectures, such as encoder-decoder transformers or generative adversarial networks, as long as they are configured to consume a prompt sentence and produce corresponding text or image data.

In yet another embodiment, the terminal may provide additional sensors such as eye-tracking or physiological sensors, and the server may incorporate these signals into the emotional state information. The same principles apply: the server converts raw sensor data into standardized features, passes them through a trained model to estimate emotion, and uses the resulting emotional state information to adjust prompt sentences, specification document information, and frame image information or prototype image information.

In each embodiment, the server, the terminal, and the user cooperate such that the server performs specific, structured data processing and data computation with defined algorithms and data structures. This cooperation produces a technical improvement in computer-implemented requirements engineering and interface prototyping by reducing processing time, increasing accuracy and consistency of generated artifacts, reducing network and computational load through emotion-guided and history-guided adjustments, and enabling automated yet technically grounded generation of coherent text and images from complex multi-modal input.

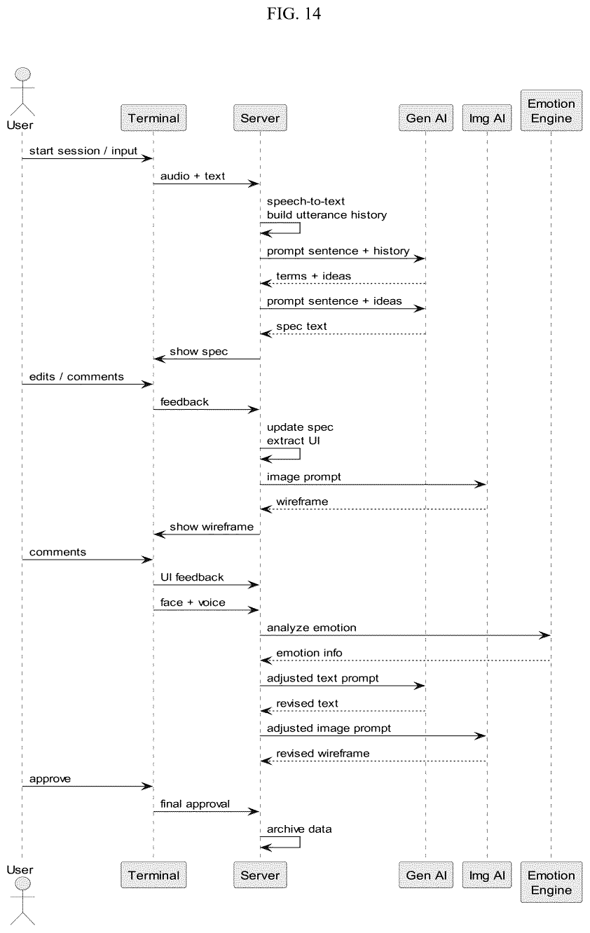

The following describes the processing flow using FIG. 14.

### Step 1:

The user operates the terminal to start a new session and select a task type such as brainstorming, requirements drafting, or UI wireframe generation. The terminal displays selectable options and collects the user's choice and optional initial description text. The terminal sends a session-start message including the selected task type, the initial description text, and a terminal identifier to the server as structured data.

Input: user selection and optional initial text entered on the terminal.

Output: session-start message transmitted from the terminal to the server.

### Step 2:

The user speaks into the microphone and optionally types additional text on the terminal. The terminal samples audio signals from the microphone at a fixed sampling rate and segments the audio stream into frames. The terminal embeds the raw audio frames into packets and transmits them to the server over a communication channel. The terminal also sends any typed character input information as text packets to the server.

Input: user speech audio and typed text at the terminal.

Output: audio packets and text packets transmitted from the terminal to the server.

### Step 3:

The server receives the audio packets and text packets from the terminal. The server passes the audio packets to a speech recognition engine, which performs feature extraction (such as Mel-frequency cepstral coefficients), decodes the features using an acoustic model and a language model, and outputs recognized character information for each audio segment. The server then merges the recognized character information with the character input information received from the terminal, sorts them by timestamp, and stores them as utterance history information in a database.

Input: audio packets and text packets from the terminal.

Output: utterance history information stored by the server.

### Step 4:

The server selects a recent portion of the utterance history information relevant to the current task type. The server constructs a prompt sentence for a generative AI model by combining a fixed instruction template with task-specific parameters and the selected utterance text. For example, the server may construct a prompt sentence such as “From the following transcript, extract key topics and summarize the main ideas.” The server tokenizes the prompt sentence and the utterance text, and sends the token sequence to the generative AI model. The model computes contextual embeddings and predicts output tokens representing related term information, concept information, and preliminary idea information. The server decodes the tokens back into text and parses the text into structured lists of terms, concepts, and ideas.

Input: utterance history information and task type information.

Output: related term information, concept information, and preliminary idea information.

### Step 5:

The server refines and expands the preliminary idea information. The server generates a new prompt sentence that explicitly instructs the generative AI model to generate multiple new ideas. For example, the server may generate “Using the following keywords, generate 10 novel ideas to improve system usability. Return them as a numbered list with brief descriptions.” The server embeds the related term information into the prompt sentence and sends the combined input to the generative AI model. The model returns generated idea information, which the server parses into an internal data structure where each idea has fields such as title, description, and source keywords.

Input: related term information, concept information, and preliminary idea information.

Output: structured idea information list generated and stored by the server.

### Step 6:

The server classifies the structured idea information into groups. The server applies a rule-based classifier that checks for presence of particular terms, and when rules are insufficient, the server sends the ideas and a classification instruction to the generative AI model. The server may use a prompt sentence such as “Classify the following ideas into coherent categories. For each category, provide a name and list its ideas.” The generative AI model returns category labels and idea-to-category assignments. The server creates category records, associates each idea with one or more categories, and computes summary information and function information for each category by calling the generative AI model with a summarization instruction.

Input: structured idea information list.

Output: categorized structured idea information with category labels, summaries, and function descriptions.

### Step 7:

The server generates specification document information. The server constructs a detailed prompt sentence for the generative AI model such as “Using the structured idea information below, draft a detailed specification document. Include sections for overview, functional requirements, non-functional requirements, usage situations, and constraints.” The server serializes the categorized structured idea information into a machine-readable format and appends it to the prompt sentence. The generative AI model outputs text that the server parses into a hierarchical document structure with named sections and subsections. The server then calls a document generation module to render this structure into a document file and stores both the document file and the internal representation.

Input: categorized structured idea information.

Output: specification document information stored as a hierarchical structure and as a document file.

### Step 8:

The terminal requests the current specification document information from the server. The server retrieves the latest document and converts it to a format suitable for display, such as HTML or a rendered page image. The terminal displays the document sections to the user in a scrollable view. The user reads the content and adds annotations, edits text fields, or flags specific items as problematic. The terminal collects these changes as evaluation information and correction instruction information and sends them to the server.

Input: specification document information from the server and user edits on the terminal.

Output: evaluation information and correction instruction information transmitted from the terminal to the server.

### Step 9:

The server receives the evaluation information and correction instruction information. The server maps each annotation or edit to corresponding sections, subsections, or items in the specification document information. The server updates the internal document structure by applying textual changes directly and by marking sections that require regeneration. For sections needing regeneration, the server calls the generative AI model with a prompt sentence that includes both the original text and the correction instruction, such as “Revise the following functional requirement section to incorporate the user's correction: [correction text].” The server replaces the affected sections with regenerated text and updates the document file.

Input: evaluation information, correction instruction information, and existing specification document information.

Output: updated specification document information and updated document file.

### Step 10:

The server analyzes the specification document information to extract operation screen information and screen component information. The server scans the document for textual patterns indicating screens and UI elements, builds a UI specification structure, and assigns each screen an identifier and purpose. The server then generates an image-generation prompt sentence for each screen, for example, “Generate a wireframe for a product search screen that includes a search bar at the top, filter options on the left, and a product list in the main area.”

The server uses this prompt sentence and a list of screen components as input to the image-generating AI model. The model iteratively denoises a latent representation to synthesize an image, and the server receives the frame image information or prototype image information and stores it along with associated metadata.

Input: specification document information and UI-related text extracted by the server.

Output: UI specification structure and generated frame image information or prototype image information.

### Step 11:

The terminal requests images associated with the current session. The server returns URLs or binary data for the frame image information or prototype image information, together with metadata describing each image. The terminal displays the images to the user in a gallery or side-by-side with corresponding sections of the specification document. The user views the images, checks whether required components are present, and may annotate the images with comments such as “move this panel to the right” or “add a help icon here.” The terminal sends these annotations to the server as evaluation information and correction instruction information for the images.

Input: frame image information or prototype image information from the server and user image annotations.

Output: image-related evaluation information and correction instruction information transmitted from the terminal to the server.

### Step 12:

The server incorporates the image-related evaluation information and correction instruction information into the UI specification structure. The server updates screen component positions, labels, and optional style hints based on the user's comments. The server then regenerates the corresponding image-generation prompt sentence to reflect the updated structure, for example, changing “filter options on the left” to “filter options at the top.” The server calls the image-generating AI model again with the revised prompt sentence and possibly modified generation condition information, receives new frame image information or prototype image information, and replaces the earlier images.

Input: image-related evaluation information, correction instruction information, and existing UI specification structure.

Output: updated UI specification structure and regenerated frame image information or prototype image information.

### Step 13:

The terminal captures facial images via the camera and voice signals via the microphone while the user views documents or images. The terminal periodically sends image frames and audio snippets to the server. The server feeds these samples into an emotion recognition engine. The engine extracts facial landmarks and voice features, processes them through trained neural network layers, and outputs probability distributions over emotion categories.

The server aggregates these probabilities over time to compute emotional state information such as “joy,” “confusion,” or “frustration” with intensity values.

Input: facial image frames and audio snippets sent from the terminal.

Output: emotional state information computed and stored by the server.

### Step 14:

The server uses the emotional state information to adjust prompt sentences and data generation behavior. When the server detects confusion during review of a certain section, the server generates an adjusted prompt sentence for the generative AI model such as “The user appears confused about the previous explanation. Re-explain the following requirement in simpler language and include two concrete examples.” When the server detects strong positive emotion associated with a group of ideas, the server increases their priority values and regenerates specification document information so that these ideas appear earlier and are described in more detail. When the server detects frustration during viewing of a dense wireframe, the server generates a new image-generation prompt sentence such as “Generate a minimal, calm wireframe using soft colors and fewer visible elements to reduce cognitive load.” The server sends these adjusted prompt sentences to the respective models and replaces earlier outputs with new ones.

Input: emotional state information, existing specification document information, and existing UI specification structure.

Output: adjusted prompt sentences and regenerated textual and visual outputs aligned with emotional state.

### Step 15:

The server records, for each invocation of the generative AI model and the image-generating AI model, the prompt sentence, tokenized input, model identifier, generation condition information, and response information. The server stores these records as input-output history in a log database. Periodically, the server retrieves batches of these records and analyzes them using an embedding model or statistical methods to detect which prompt patterns correlate with high user approval and fewer subsequent corrections. The server then constructs new prompt templates with improved wording or parameter settings and registers them as reusable prompt patterns. In future sessions, the server selects these optimized patterns when generating initial prompt sentences, thereby reducing the number of iterations required to achieve acceptable results.

Input: prompt sentences, generation condition information, response information, and user feedback indicators.

Output: optimized prompt patterns and updated prompt generation rules stored by the server.

### Step 16:

The user eventually approves the specification document information and the associated frame image information or prototype image information on the terminal. The terminal sends an approval message for the current session to the server. The server receives the approval, marks the specification document information and images as final, and archives the complete set of session data, including utterance history information, structured idea information, specification document versions, UI specifications, images, emotional state logs, and input-output history. The server may then export the final artifacts for use in downstream systems such as development tools or manufacturing control systems.

Input: approval message from the terminal and all accumulated session data.

Output: finalized and archived specification document information and visual artifacts, available for external technical use.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

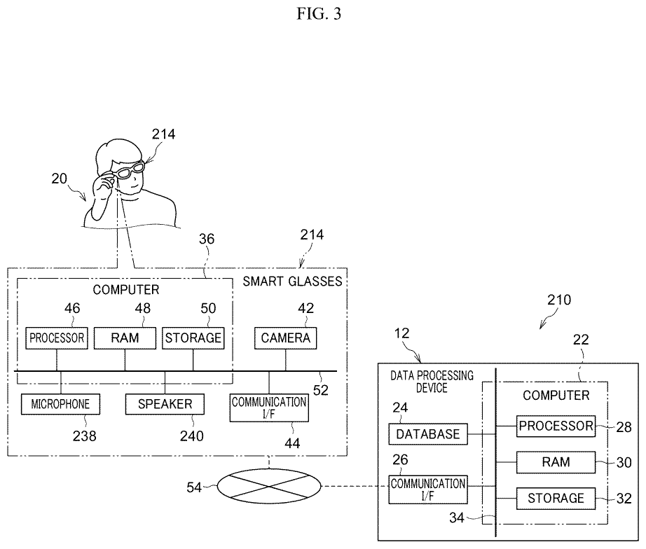

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

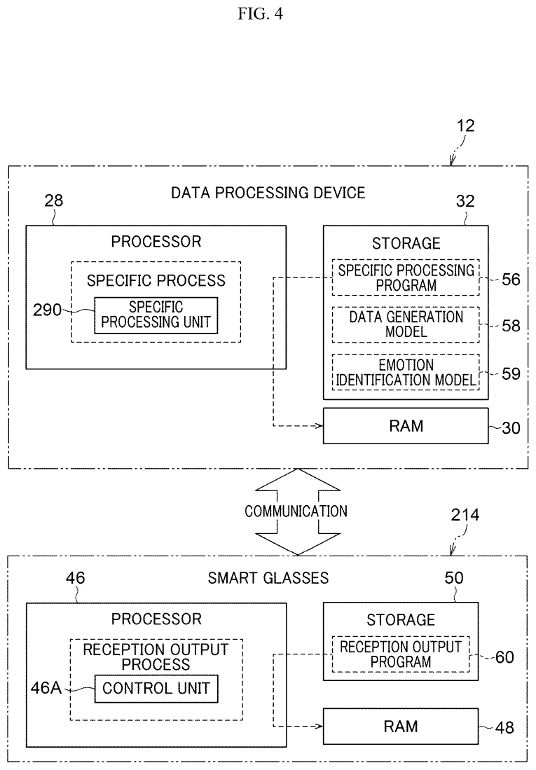

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

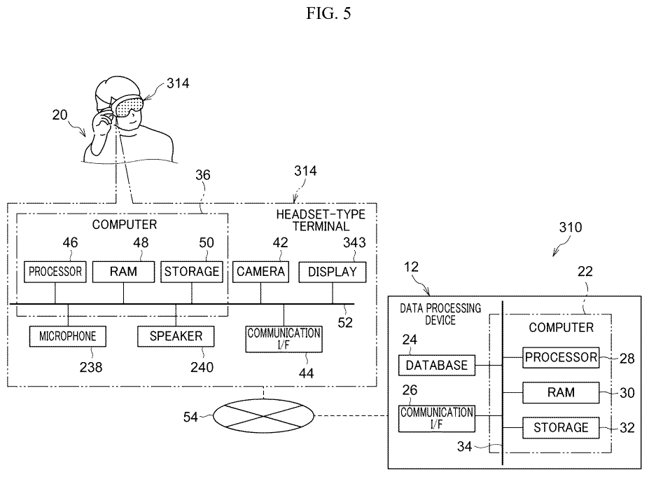

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

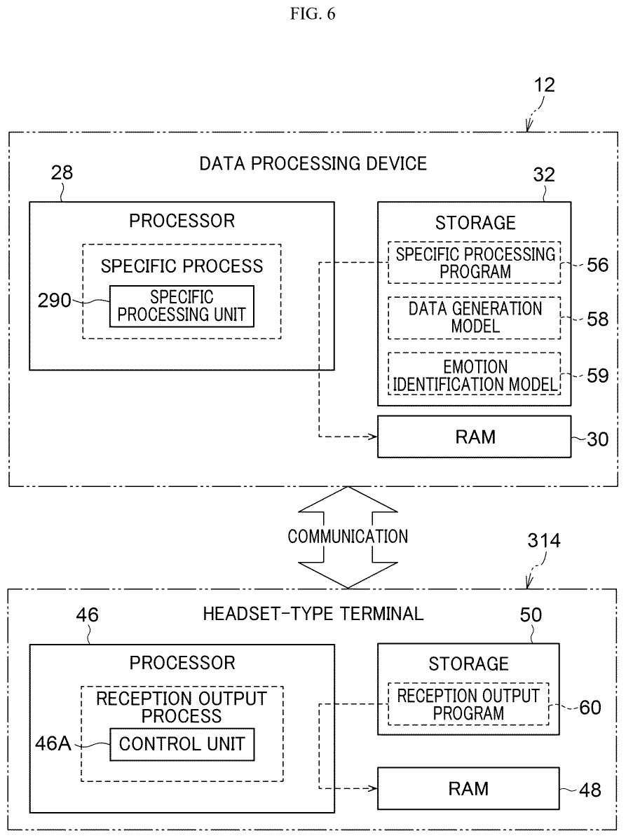

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

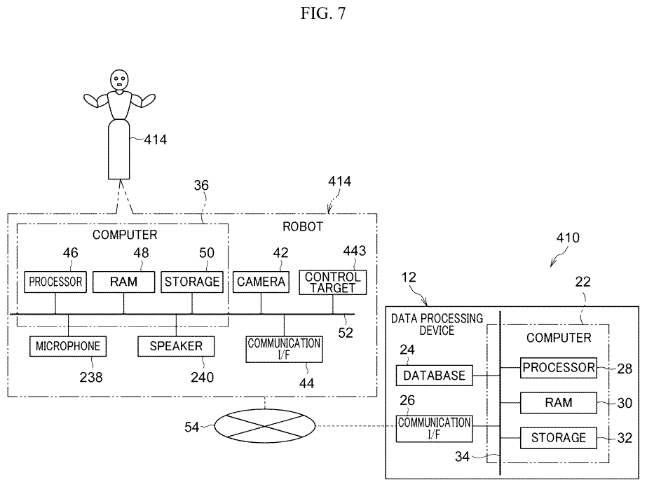

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

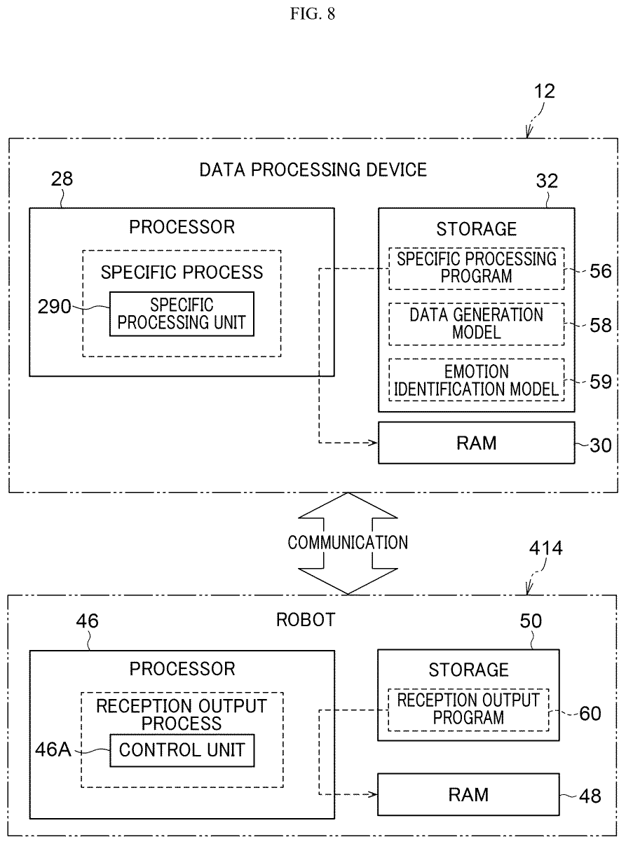

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

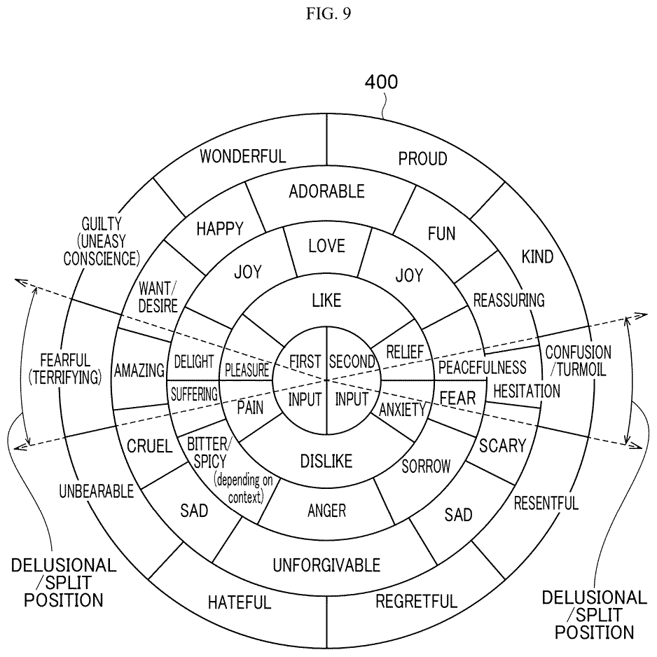

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

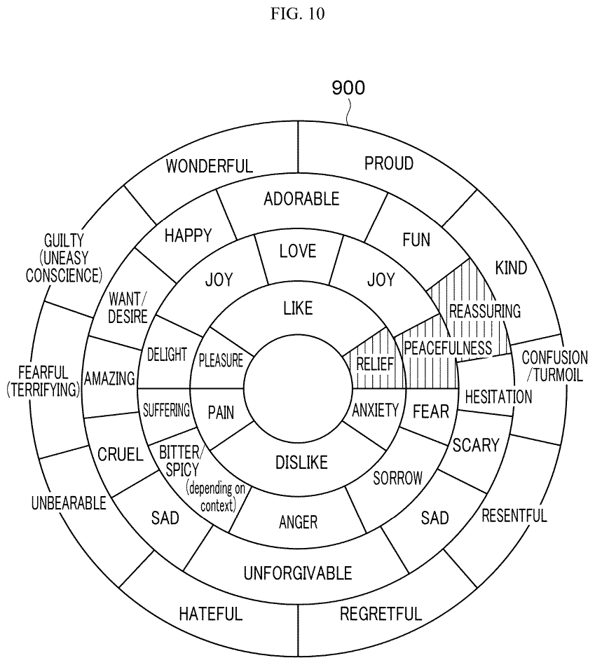

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive audio information transmitted from a terminal that acquires utterances of a participant, analyze the audio information, convert the audio information into character information in real time, and store the character information as storage information, preprocess the stored character information based on the storage information, generate a prompt sentence including the preprocessed character information, input the prompt sentence into a generative artificial intelligence model, and extract related expressions from an output of the generative artificial intelligence model,
generate a prompt sentence including the extracted related expressions, input the prompt sentence into the generative artificial intelligence model, generate a plurality of idea information items based on an output of the generative artificial intelligence model, and store the idea information items as structured information in the storage information,
convert the structured idea information into display data for the terminal and into audio output data, and transmit the display data and the audio output data to the terminal so as to present the structured idea information to the participant,
collect evaluation information or comment information transmitted from the terminal as feedback information, store the feedback information as part of the storage information, generate a prompt sentence including the feedback information, input the prompt sentence into the generative artificial intelligence model, and update or additionally generate the idea information based on an output of the generative artificial intelligence model, and associate, on a session basis, the audio information, the character information, the related expressions, the idea information, and the feedback information, record the associated information in the storage information, and dynamically change generation conditions of the prompt sentence to be input into the generative artificial intelligence model based on the recorded association.

### (Supplementary 2)

The system according to supplementary 1,
wherein the processor is configured to
generate, based on the feedback information and the structured idea information, a specification document including functional requirements, non-functional requirements, and usage scenarios, and output the specification document as requirement-definition information or planning information.

### (Supplementary 3)

The system according to supplementary 1,
wherein the processor is configured to
generate a prompt sentence based on the specification document and the structured idea information, input the prompt sentence into an image generation processing model, generate shape data including configuration information or appearance information by the image generation processing model, and output the shape data as design material or prototyping material.

### Application Example 1

### (Supplementary 1)

A system comprising a processor,
wherein the processor is configured to
acquire utterances of participants from an acoustic input device connected to a plurality of information processing devices, and store the utterances as acoustic information associated with time information and identification information,
perform acoustic recognition processing on the acoustic information to convert the utterances into character information indicating utterance content, remove unnecessary information from the character information, and organize the character information as text information classified by topic,
generate a prompt sentence including the organized text information, input the prompt sentence to a generative AI model including a large-scale generative model, and cause the generative AI model to output related terms regarding work efficiency improvement and new ideas based on the related terms,
analyze the new ideas output from the generative AI model, convert the new ideas into structured improvement information including an objective, operation procedure, resource information, and effect information, and edit the structured improvement information into display information including a document and an image, and
transmit the display information to the plurality of information processing devices, acquire feedback information through viewing and selection of the display information by the participants, and reflect the feedback information in the prompt sentence input to the generative AI model so as to iteratively improve generation processing of the new ideas.

### (Supplementary 2)

The system according to supplementary 1,
wherein the processor is configured to automatically generate a specification document or a concept document including requirement items, constraint conditions, and execution procedures regarding work improvement, based on the feedback information and the structured improvement information.

### (Supplementary 3)

The system according to supplementary 1,
wherein the processor is configured to generate drawing data or prototype data indicating process layout, apparatus configuration, or prototype shape, by performing image generation processing or design processing based on the specification document or the concept document and the structured improvement information.

### Example 2

### (Supplementary 1)

A system comprising a processor,
wherein the processor is configured to
sequentially acquire audio information of participants over time and convert the audio information into character information,
receive a prompt sentence from a user together with the character information as input information and supply the input information to a generative AI model including a generative language model to generate, in a natural language, a plurality of idea information items related to the input information,
analyze the plurality of idea information items using the generative AI model or a natural language processing program to perform phrase analysis and statistical processing, and split and extract the plurality of idea information items as individual idea information items, numerically convert the individual idea information items using a semantic representation vector generation model and a classification program and, based on a predetermined classification criterion, organize the individual idea information items by category as functional classification information or application classification information,
automatically generate internal prompt sentences including the individual idea information items and category information thereof, input the internal prompt sentences to the generative AI model, and generate, for each of the individual idea information items, detailed explanation information including purpose information, function information, and usage scene information,
integrate the detailed explanation information in accordance with a predetermined document structure rule and automatically generate, as a project start document, a requirements definition document or a concept document,
transmit the plurality of idea information items and the requirements definition document or the concept document to a display terminal, present the plurality of idea information items and the requirements definition document or the concept document to the participants, and collect feedback information as evaluation information or correction instruction information, and
store, as storage information, a correspondence between the feedback information and the idea information items and the detailed explanation information, and reflect the stored correspondence in a subsequent idea generation process or document generation process.

### (Supplementary 2)

The system according to supplementary 1,
wherein the processor is configured to, when generating the requirements definition document or the concept document, input the detailed explanation information and, based on a predetermined document template and an editing rule, assign a heading structure, an item structure, and priority information to generate a formalized specification document.

### (Supplementary 3)

The system according to supplementary 1,
wherein the processor is configured to use an image generation technology including an image generation model, with the detailed explanation information or the requirements definition document or the concept document as input, to automatically generate design image information or prototype image information including functional configuration diagrams, screen configuration diagrams, and external prototype diagrams.

### Application Example 2

### (Supplementary 1)

A system comprising a processor,
wherein the processor is configured to
acquire utterances of a participant and sequentially convert audio information of the utterances into character information,
integrate the character information with character input information from the participant and store the integrated information as utterance history information,
generate a prompt sentence for a generative AI model on the basis of the utterance history information, and use the prompt sentence to cause the generative AI model to extract related term information and concept information and to generate new idea information, classify the generated idea information into groups according to a classification criterion, and for each group, add summary information and function information to organize the idea information as structured idea information,
automatically create specification document information including overview information, functional requirement information, non-functional requirement information, usage situation information, and constraint condition information on the basis of the structured idea information,
extract operation screen information between a user and an apparatus and screen component information from the specification document information, generate an image generation prompt sentence on the basis of an extraction result, and use the image generation prompt sentence to cause an image-generating AI model to generate frame image information or prototype image information,
present the generated frame image information or prototype image information and the specification document information to the participant, acquire evaluation information and correction instruction information from the participant, and iteratively update the specification document information and the frame image information or the prototype image information, and
acquire facial expression information and voice feature information of the participant, estimate emotional state information, and dynamically adjust generation contents of at least one of the prompt sentence, the specification document information, and the frame image information or the prototype image information on the basis of the emotional state information.

### (Supplementary 2)

The system according to supplementary 1,
wherein the processor is configured to
change priority information of the idea information on the basis of the emotional state information, and regenerate the specification document information reflecting the priority information.

### (Supplementary 3)

The system according to supplementary 1,
wherein the processor is configured to
record, as input-output history with the generative AI model and the image-generating AI model, the prompt sentence, response information, and generation condition information, and analyze the recorded input-output history to perform automatic generation or candidate presentation of a future prompt sentence.

What is claimed is:

1. A system comprising:
circuitry configured to:
receive, via a communication interface coupled to a packet-switched network, audio information from a terminal device, convert the audio information into character information in real time using speech recognition processing, and store the character information as storage information indexed by session information;
preprocess the stored character information and generate a first prompt sentence including the preprocessed character information, input the first prompt sentence into a generative neural network model, and extract related expressions from an output of the generative neural network model;
generate a second prompt sentence including the extracted related expressions, input the second prompt sentence into the generative neural network model, generate a plurality of idea information items based on an output of the generative neural network model, and store the idea information items as structured information in the storage information;
apply phrase analysis and statistical processing to the plurality of idea information items to split and extract individual idea information items, convert the individual idea information items into semantic representation vectors using a semantic representation vector generation model, and organize the individual idea information items by category as classification information based on a predetermined classification criterion;
generate internal prompt sentences including the individual idea information items and the classification information, input the internal prompt sentences to the generative neural network model, and generate for each idea information item detailed explanation information including purpose information, function information, and usage scene information;
integrate the detailed explanation information in accordance with a predetermined document structure rule to automatically generate a structured document, and transmit the structured document and the plurality of idea information items to the terminal device via the communication interface; and
collect feedback information from the terminal device, store the feedback information as part of the storage information, generate an updated prompt sentence including the feedback information, and input the updated prompt sentence into the generative neural network model to update or additionally generate idea information items.

2. The system according to claim 1, wherein the circuitry is configured to dynamically change generation conditions of the prompt sentences input to the generative neural network model based on a recorded association among the audio information, the character information, the related expressions, the idea information items, and the feedback information stored in the storage information.

3. The system according to claim 2, wherein the circuitry is configured to receive a prompt sentence from a user via the terminal device together with the character information as input information, supply the input information to the generative neural network model, and generate the plurality of idea information items in a natural language from the input information.

4. The system according to claim 3, wherein the circuitry is configured to apply a classification program to the semantic representation vectors using a predetermined classification criterion to organize the individual idea information items as functional classification information or application classification information.

5. The system according to claim 4, wherein the circuitry is configured to generate, based on the feedback information and the structured idea information, a specification document including functional requirements, non-functional requirements, and usage scenarios, and output the specification document as requirement-definition information or planning information.

6. The system according to claim 1, wherein the circuitry is configured to acquire audio information of participants from an acoustic input device connected to a plurality of terminal devices, store the audio information as acoustic information associated with time information and identification information, and perform acoustic recognition processing on the acoustic information to convert the audio information into character information classified by topic.

7. The system according to claim 6, wherein the circuitry is configured to generate a prompt sentence including the character information classified by topic, input the prompt sentence to the generative neural network model, and cause the generative neural network model to output related terms and new ideas based on the related terms.

8. The system according to claim 7, wherein the circuitry is configured to analyze the new ideas output from the generative neural network model, convert the new ideas into structured improvement information including an objective, operation procedure, resource information, and effect information, and edit the structured improvement information into display information including at least one of a document and an image.

9. The system according to claim 8, wherein the circuitry is configured to transmit the display information to the plurality of terminal devices, acquire feedback information through interaction with the display information, and update the structured improvement information based on the feedback information.

10. The system according to claim 1, wherein the circuitry is configured to apply preprocessing to the stored character information by removing unnecessary information and organizing the character information as text information classified by topic prior to generating the first prompt sentence.

11. The system according to claim 10, wherein the circuitry is configured to compute semantic similarity between individual idea information items using the semantic representation vectors, and cluster semantically similar idea information items into a same category in the classification information.

12. The system according to claim 11, wherein the circuitry is configured to select generation conditions for the internal prompt sentences based on the classification information, and adjust a level of detail and an output format of the detailed explanation information based on the category assigned to each idea information item.

13. The system according to claim 12, wherein the circuitry is configured to generate a project start document by integrating the detailed explanation information from a plurality of idea information items according to the document structure rule, the project start document including at least a requirements definition section and a concept description section.

14. The system according to claim 1, wherein the circuitry is configured to convert the structured document into display data for the terminal device and into audio output data, and transmit the display data and the audio output data to the terminal device so as to present the structured document to a participant via at least one of a display device and an audio output device.

15. The system according to claim 14, wherein the circuitry is configured to generate an image generation prompt sentence based on the structured document, transmit the image generation prompt sentence to an image generation model via the communication interface, and receive visual prototype data generated by the image generation model representing a prototype corresponding to the structured document.

16. The system according to claim 15, wherein the circuitry is configured to transmit the visual prototype data to the terminal device via the communication interface and display the visual prototype data alongside the structured document for review by a participant.

17. The system according to claim 1, wherein the circuitry is configured to associate, on a session basis, the audio information, the character information, the related expressions, the idea information items, and the feedback information, and record the associated information in the storage information indexed by session identifier and timestamp for subsequent retrieval and processing.

18. A system comprising:
circuitry configured to:
receive, via a communication interface coupled to a packet-switched network, audio information from a terminal device, convert the audio information into character information in real time using speech recognition processing, and store the character information indexed by session information;
preprocess the character information and generate a first prompt sentence, input the first prompt sentence to a generative neural network model to extract related expressions, generate a second prompt sentence including the related expressions, and input the second prompt sentence to the generative neural network model to generate a plurality of idea information items;
apply phrase analysis and statistical processing to split the idea information items, convert the individual idea information items into semantic representation vectors using a semantic representation vector generation model, and organize the individual idea information items by category using a classification program;
generate internal prompt sentences including the individual idea information items and classification information, input the internal prompt sentences to the generative neural network model to generate detailed explanation information for each idea information item, and integrate the detailed explanation information according to a document structure rule to generate a structured document;
generate an image generation prompt sentence based on the structured document, transmit the image generation prompt sentence to an image generation model, and receive visual prototype data from the image generation model; and
collect feedback information from the terminal device, update idea information items based on the feedback information, and transmit the structured document and the visual prototype data to the terminal device via the communication interface.

19. The system according to claim 18, wherein the circuitry is configured to dynamically change generation conditions of the prompt sentences based on a recorded association among the audio information, the character information, the idea information items, and the feedback information stored in the storage information.

20. A method comprising:
receiving, via a communication interface coupled to a packet-switched network, audio information from a terminal device, converting the audio information into character information in real time using speech recognition processing, and storing the character information as storage information;
preprocessing the stored character information and generating a first prompt sentence, inputting the first prompt sentence into a generative neural network model to extract related expressions from an output of the generative neural network model;
generating a second prompt sentence including the related expressions, inputting the second prompt sentence into the generative neural network model to generate a plurality of idea information items, and storing the idea information items as structured information in the storage information;
applying phrase analysis and statistical processing to split and extract individual idea information items, converting the individual idea information items into semantic representation vectors using a semantic representation vector generation model, and organizing the individual idea information items by category as classification information;
generating internal prompt sentences including the individual idea information items and the classification information, inputting the internal prompt sentences to the generative neural network model to generate detailed explanation information for each idea information item, and integrating the detailed explanation information according to a document structure rule to generate a structured document;
transmitting the structured document and the plurality of idea information items to the terminal device via the communication interface; and
collecting feedback information from the terminal device, generating an updated prompt sentence including the feedback information, and inputting the updated prompt sentence into the generative neural network model to update or additionally generate idea information items.
